(19) United States
(12) Patent Application Publication
(10) Pub. No.: US 2025/0159056 A1
(43) Pub. Date: May 15, 2025

(54) OPERATION MODES FOR A COMPUTING DEVICE

(71) Applicant: NRS Systems, Yakima, WA (US)

(72) Inventors: John Michael Gehlsen, Yakima, WA (US); Kyle Aaron Discher, Kirkland, WA (US); Evan Lee St. John, Yakima, WA (US); Jeffrey Brian Jarvis, Tyler, TX (US); Raul Rodriguez, Yakima, WA (US); Lee Eric Mandel, Massapequa, NY (US)

(73) Assignee: NRS Systems, Yakima, WA (US)

(21) Appl. No.: 18/388,308

(22) Filed: Nov. 9, 2023

(51) Int. Cl. H04L 67/306; H04L 67/303

(52) U.S. Cl. CPC H04L 67/306; H04L 67/303

(57) ABSTRACT

Techniques for operation modes for a computing device are described and may be implemented to enable a computing device to operate in different operation modes, such as a standalone mode, a user mode, a schedule mode, and so forth. Further, a system is provided with a switch devices attached to a hub device to enable actuation of the switch devices to trigger different action plans via the hub device. An architecture is provided that enables devices at a local facility to be configured by a remote resource and the devices to remain operable when connectivity to the remote resource is interrupted.

### BACKGROUND

Today's computing devices can be used for a variety of different purposes, such as productivity tasks, entertainment, communication, and so forth. Further, computing devices are often deployed in different facilities for performing different tasks such as tasks related to enterprise purposes.

### BRIEF DESCRIPTION OF THE DRAWINGS

Aspects of operation modes for a computing device are described with reference to the following Figures. The same numbers may be used throughout to reference similar features and components that are shown in the Figures:

FIG. 1 illustrates an example environment in which aspects of operation modes for a computing device can be implemented.

FIG. 2 depicts an example system that supports implementations for operation modes for a computing device.

FIG. 3 depicts an example implementation of the device profile in accordance with implementations for operation modes for a computing device.

FIG. 4 depicts an example system that supports implementations for operation modes for a computing device.

FIG. 5 depicts an example profile GUI that supports implementations for operation modes for a computing device.

FIG. 6 depicts an example system that supports implementations for operation modes for a computing device.

FIG. 7 depicts an example system profile GUI that supports implementations for operation modes for a computing device.

FIG. 8 depicts an example system that supports implementations for operation modes for a computing device.

FIG. 9a depicts an example scenario for configuring scheduling in accordance with implementations for operation modes for a computing device.

FIG. 9b depicts an example scenario for configuring scheduling in accordance with implementations for operation modes for a computing device.

FIG. 9c depicts an example scenario for configuring scheduling in accordance with implementations for operation modes for a computing device.

FIG. 10a depicts an example scenario for configuring scheduling in accordance with implementations for operation modes for a computing device.

FIG. 10b depicts an example scenario for configuring scheduling in accordance with implementations for operation modes for a computing device.

FIG. 10c depicts an example scenario for configuring scheduling in accordance with implementations for operation modes for a computing device.

FIG. 11a depicts an example scenario for configuring scheduling in accordance with implementations for operation modes for a computing device.

FIG. 11b depicts an example scenario for configuring scheduling in accordance with implementations for operation modes for a computing device.

FIG. 11c depicts an example scenario for configuring scheduling in accordance with implementations for operation modes for a computing device.

FIG. 12a depicts an example scenario for configuring scheduling in accordance with implementations for operation modes for a computing device.

FIG. 12b depicts an example scenario for configuring scheduling in accordance with implementations for operation modes for a computing device.

FIG. 12c depicts an example scenario for configuring scheduling in accordance with implementations for operation modes for a computing device.

FIG. 13 depicts a method for operation modes for a computing device in accordance with one or more implementations.

FIG. 14 depicts a method for operation modes for a computing device in accordance with one or more implementations.

FIG. 15 depicts a method for operation modes for a computing device in accordance with one or more implementations.

FIG. 16 depicts an environment in accordance with one or more implementations.

FIG. 17 depicts a method for utilizing a switch device for implementing an action plan in accordance with one or more implementations.

FIG. 18 depicts a light fixture in accordance with one or more implementations.

FIG. 19 depicts the light fixture with the cap component removed from the base component in accordance with one or more implementations.

FIG. 20 depicts the light fixture with the cap component removed from the base component in accordance with one or more implementations.

FIG. 21 depicts an overhead view of the light fixture with the cap component removed from the base component in accordance with one or more implementations.

FIG. 22 depicts an example alert device in accordance with one or more implementations.

FIG. 23 depicts an example architecture 2300 in accordance with one or more implementations.

FIG. 24 depicts a method for facility operation in the context of a distribute architecture in accordance with one or more implementations.

FIG. 25 illustrates an example system that includes an example computing device that is representative of one or more computing systems and/or devices that are usable to implement the various techniques described herein.

### DETAILED DESCRIPTION

Techniques for operation modes for a computing device are described and may be implemented to enable a computing device to be configured to operate in a particular operation mode and/or to switch between operation in different operation modes. For instance, the computing device is implemented as a kiosk device that is deployed within a facility such as an enterprise facility, an education facility, a government facility, and so forth. The kiosk device, for example, is positioned to receive interaction by different users within the context of the facility.

In implementations, different operation modes for a computing device include a user mode, a standalone mode, and a schedule mode. The user mode, for example, is operable within the context of a user profile, such as for a user that authenticates and/or interacts with the computing device. For instance, the user profile is associated with different settings that are used to control operation of the computing device, such as permissions, device behaviors, user preferences, and so forth. Thus, in the user mode, operation of the computing device is adapted to a user-specific user experience.

In implementations, a computing device is operable in the standalone mode to operate independent of a user context. For instance, in the standalone mode, the computing device operates according to settings and behaviors that are independent of a user identity and/or user profile that interacts with the computing device. A standalone mode, for example, enables operation of the computing device to be adapted to different purposes that are independent of a particular user that interacts with the computing device.

In implementations, the schedule mode enables a computing device to operate according to a schedule that specifies different operation modes for the computing device based on different temporal parameters. For instance, a schedule can be generated for the computing device that specifies different time periods during which the computing device is to operate in different operation modes, and times at which the computing device is to switch between different operation modes. For instance, the schedule can specify times at which the computing device is to switch from the standalone mode to the user mode, and times at which the computing device is to switch from the user mode to the standalone mode.

In implementations, user-initiated switching between different operation modes is provided. For instance, when a computing device is operating in the standalone mode, a user can request that operation of the computing device switch to the user mode, and vice-versa. User-initiated switching between different operation modes can be controlled in various ways, such as based on device-specific permissions, user-specific permissions, facility-specific permissions, and so forth.

Accordingly, techniques for operation modes for a computing device enable a computing device (e.g., a kiosk device) to be configured to operate in a particular operation mode and/or set of operation modes. In implementations, the described techniques enable single device to be utilize for various purposes, thus conserving device and/or organizational resources.

While features and concepts of operation modes for a computing device can be implemented in any number of different devices, systems, environments, and/or configurations, aspects of operation modes for a computing device are described in the context of the following example devices, systems, and methods.

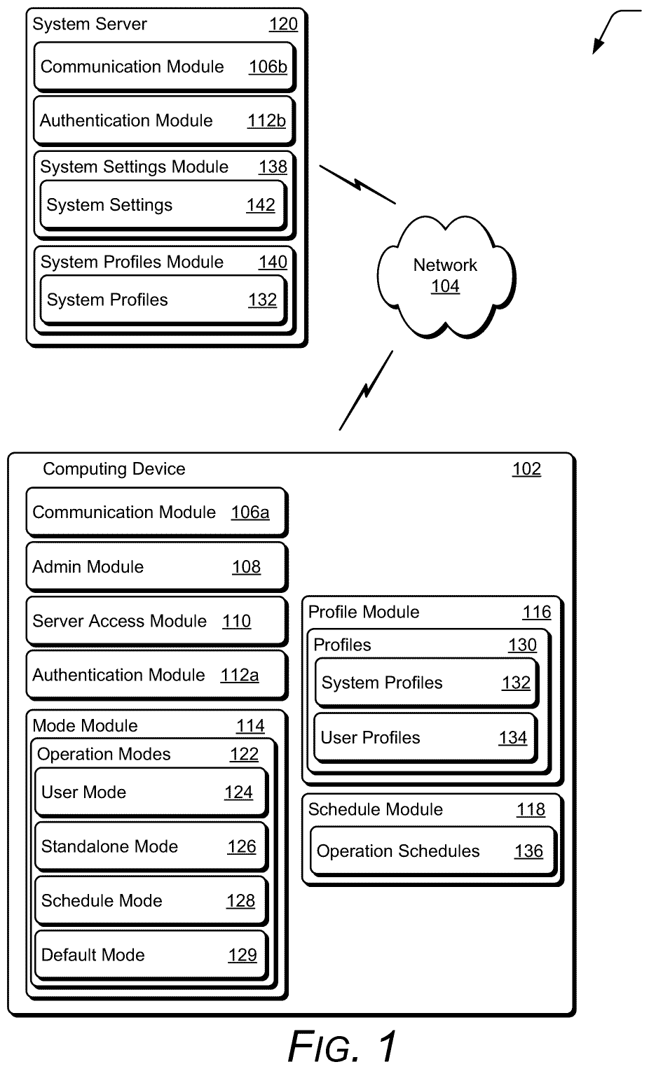

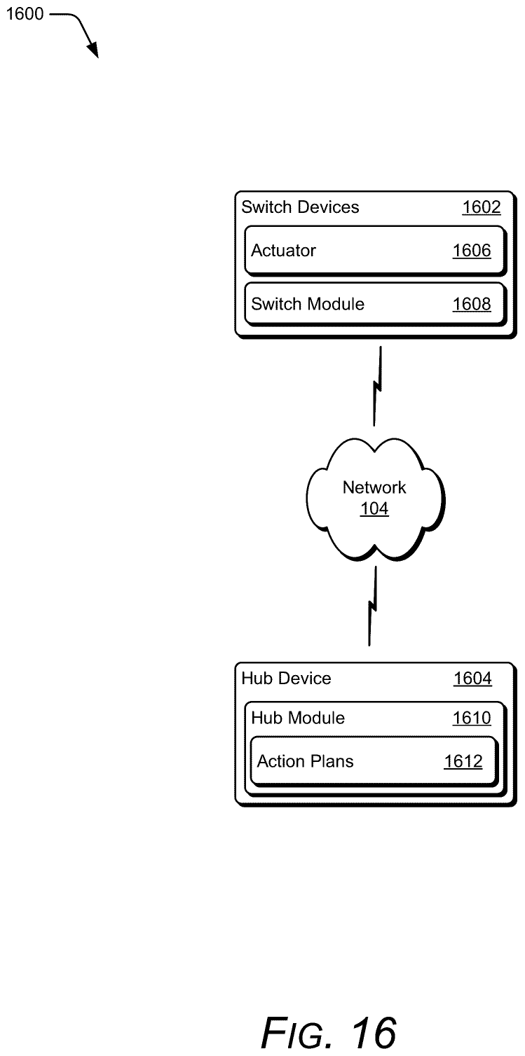

FIG. 1 illustrates an example environment 100 in which aspects of operation modes for a computing device can be implemented. The example environment 100 includes a computing device 102 that is connectable to network 104. Generally, the computing device 102 can be implemented via any suitable computing architecture, such as a desktop computer, a portable device (e.g., a tablet computer, a smartphone, a wearable device), a server device, and so forth. These examples are not to be construed as limiting, however, and the computing device 102 can be implemented in a variety of different ways and form factors. Further example attributes of the computing device 102 are discussed below with reference to the device 1602 of FIG. 16. The network 104 can be implemented using any suitable network architecture including wired, wireless, and combinations thereof.

The computing device 102 includes various functionality that enables implementations for operation modes for a computing device, including a communication module 106a, an administration (“admin”) module 108, a server access module 110, an authentication module 112a, a mode module 114, a profile module 116, and a schedule module 118. The communication module 106a represents functionality for enabling the computing device 102 to transmit and receive data in various ways, such as via wired and wireless communication protocols. The communication module 106a, for instance, enables the computing device 102 to transmit and receive data via wired and/or wireless connectivity to the network 104.

The admin module 108 represents functionality for controlling various administrative activities of the computing device 102, such as initial configuration of the computing device 102, reconfiguration of the computing device 102, and so forth. For instance, the admin module 108 can enable initial configuration of different operational settings of the computing device 102 when the computing device 102 is initially powered up. Further, the admin module 108 can enable reconfiguration of different operational settings of the computing device 102 at any time.

The server access module 110 represents functionality to enable connectivity and data exchange between the computing device 102 and a system server 120. The server access module 110, for instance, enables the computing device 102 to exchange data with the system server 120 via the network 104. As further detailed below, the system server 120 represents functionality for configuring and managing aspects of operation modes for a computing device.

The authentication module 112a represents functionality for authenticating access to the computing device 102. The authentication module 112a, for instance, can implement various types of authentication techniques for controlling access to the computing device 102, such as passwords, physical authentication (e.g., machine-readable objects such as radio-frequency identification (RFID) objects, scannable codes (e.g., bar codes), etc.), biometrics (e.g., recognition of facial features, fingerprints, retinal features, voice features, etc.), multi-factor authentication, and so forth.

The mode module 114 represents functionality for enabling operation of the computing device 102 in different operation modes 122. Different operation modes 122, for instance, provide for different user experiences, access permissions, accessible functionalities, and so forth. In this particular example the operation modes 122 include a user mode 124, a standalone mode 126, a schedule mode 128, and a default mode 129. The default mode 129, for instance, represents an operation mode in which the computing device 102 is to operate by default. Different attributes of the user mode 124, the standalone mode 126, the schedule mode 128, and the default mode 129 are detailed below.

The profile module 116 represents functionality for generating and managing different profiles 130 for the computing device 102. Instances of the profiles 130, for example, can be associated with different user experiences, access permissions, data storage locations, accessible functionalities, and so forth. In this particular example the profiles 130 includes system profiles 132 and user profiles 134. Different attributes of the system profiles 132 and the user profiles 134 are detailed below.

The schedule module 118 represents functionality for managing operational scheduling for the computing device 102. The schedule module 118, for instance, enables creation and management of operation schedules 136 for the computing device 102. As further detailed below, the operation schedules 136 can specify operational parameters for the computing device 102 that are operable and/or not operable as specific times, days, dates, and so forth. Further details concerning the schedule module 118 and the operation schedules 136 are provided below.

Further to the environment 100 and as referenced above, the system server 120 represents functionality for configuring and managing aspects of operation modes for a computing device described herein. For instance, user interaction with the system server 120 enables operational attributes of the computing device 102 to be configured. Accordingly, the system server 120 includes various functionality including a communication module 106b, an authentication module 112b, a system settings module 138, and a system profiles module 140.

The communication module 106b represents functionality for enabling the system server 120 to transmit and receive data in various ways, such as via wired and wireless communication protocols. The communication module 106b, for instance, enables the system server 120 to transmit and receive data via wired and/or wireless connectivity to the network 104, such as for wired and/or wireless communication with the computing device 102.

The system settings module 138 represents functionality for configuring and managing system settings 142. The system settings 142, for instance, represent various settings for configuring and controlling operation of the computing device 102 and/or other devices associated with the system server 120. In at least one implementation, the admin module 108 and the server access module 110 of the computing device 102 can interact with the system server 120 to obtain system settings 142 for configuring operation of the computing device 102, such as for generating, configuring, and reconfiguring the profiles 130.

The system profiles module 140 represents functionality for configuring and managing system profiles 132. The system profiles 132, for instance, specify different system behaviors such as operational parameters of the computing device 102 and other devices associated with the system server 120. In at least one implementation the system profiles 132 can specify different behaviors for different devices and/or sets of devices, such as based on group membership for different instances of devices, e.g., the computing device 102.

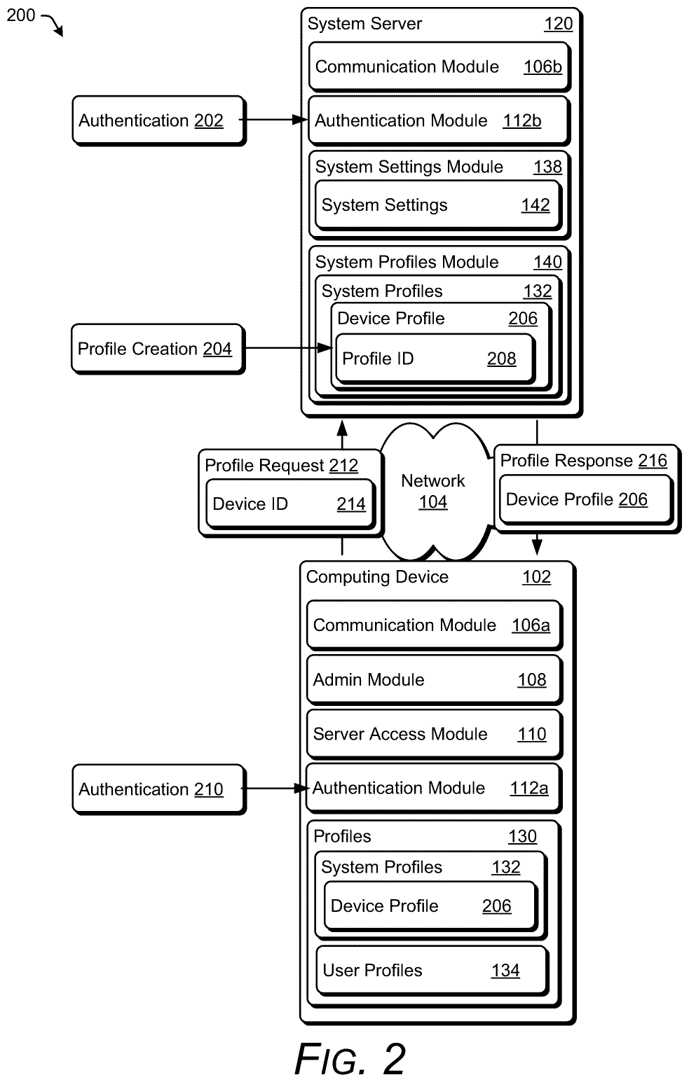

FIG. 2 depicts an example system 200 that supports implementations for operation modes for a computing device. In the system 200, a user (e.g., an admin user) performs authentication 202 with the authentication module 112b of the system server 120. After authenticating with the system server 120, the user performs profile creation 204 to generate a device profile 206 as part of the system profiles 132. The device profile 206 can include various information such as an operation mode 122, an operation schedule 136, user profiles 134 associated with the device profile 206, specific organizational settings, and so forth. Further, the device profile 206 includes a profile identifier (ID) 208 that identifies the device profile 206. While the system profiles 132 are depicted as including a single device profile 206, it is to be appreciated that multiple different device profiles 206 can be generated, each with its own particular settings and profile ID 208.

Further to the system 200, a user (e.g., an admin user) performs an authentication 210 with the authentication module 112a of the computing device 102. In at least one implementation, the authentication 210 is performed when the computing device 102 is initially power up, e.g., upon initial deployment of the computing device 102 to a location. Alternatively or additionally the authentication 210 can be performed as part of reconfiguration of the computing device 102.

After the authentication 210 with the authentication module 112a, the admin module 108 and the server access module 110 can communication a profile request 212 to the system server 120. In at least one implementation the profile request 212 includes a device ID 214 that identifies the computing device 102, such as an identifier assigned to the computing device 102 by an admin user. The system profiles module 140 receives the profile request 212 and identifies the profile ID 208 to be provided to the computing device 102. The system profiles module 140, for instance, matches the device ID 214 to the profile ID 208 for the device profile 206. The system server 120 communicates a profile response 216 that includes the device profile 206 to the computing device 102. The device profile 206, for instance, can be stored as part of the system profiles 132 for controlling operation of the computing device 102. In at least one implementation, where the device profile 206 includes instances of user profiles, the user profiles can be propagated to the user profiles 134 of the profiles 130.

In alternative or additional implementations to the system 200, the computing device 102 can be directly configured with the device profile 206. For instance, a device manufacturer personnel for the computing device 102 can interact with the admin module 108 to generate and configure the device profile 206 and/or multiple device profiles 206, e.g., independently of or additionally to interaction with the system server 120. Thus, when the computing device 102 is initially deployed and power up, an admin user can select the device profile 206 and/or a set of device profiles 206 to be used to control operation of the computing device 102.

In another alternative or additional implementation to the system 200, the admin module 108 can be configured to automatically retrieve the device profile 206 upon startup. For instance, when the computing device 102 is powered up (e.g., a first time as part of initial deployment) the admin module 108 can automatically invoke the server access module 110 to access the system server 120, transmit the profile request 212 including the device ID 214, and retrieve the device profile 206 for configuration of the computing device 102. The computing device 102, for instance, can access the system server 120 and retrieve the device profile 206 automatically and independent of user interaction after initial power up of the computing device 102.

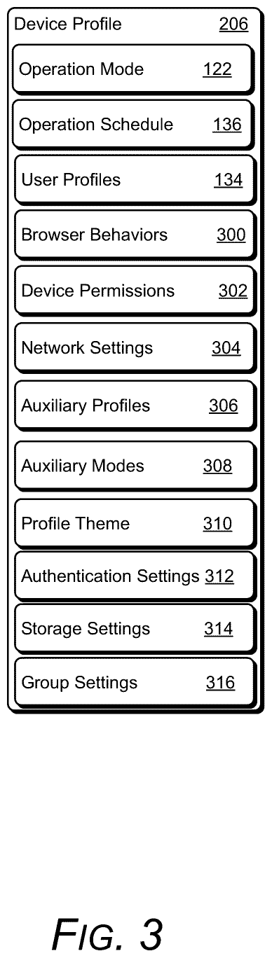

FIG. 3 depicts an example implementation of the device profile 206 in accordance with implementations for operation modes for a computing device. The device profile 206, for instance, includes different operating parameters such as for the computing device 102. In this particular example the device profile 206 specifies an operation mode 122, an operation schedule 136, user profiles 134, browser behaviors 300, device permissions 302, network settings 304, auxiliary profiles 306, auxiliary modes 308, profile theme 310, authentication settings 312, storage settings 314, and group settings 316.

The operation mode 122 specifies which particular operation mode 122 and/or combination of operation modes 122 in which the computing device 102 is operable. Examples of the operations modes 122 are introduced above, and include the user mode 124, the standalone mode 126, and schedule mode 128.

Example attributes of the user mode 124 include:
User profiles—individual users can be assigned respective user profiles that are associated with user-specific information such as contact information, user role(s), user permissions, user-specific browser settings (e.g., browser permissions), user data storage locations, etc.
User credentials—when the user mode 124 is active on a device, user credentials can be required to enable access to the device. In implementations, when valid user credentials for a user profile are entered on a device, the device can present a browser that is configured based on the user profile.
Data storage—in the user mode 124, user-specific data storage locations can be specified. For instance, individual user profiles 134 can be associated with specific data storage locations, such as local data storage locations, network-based (e.g., cloud-based) storage locations, etc.
Application access—a user that successfully authenticates in a user mode may automatically have access to applications that are designated to execute when a user mode is active.
Application data—applications executing on a device in user mode 124 may access user-specific data, such as from a database that stores user profiles 134. In implementations, this enables a user that is successfully authenticated in a user mode to be automatically authenticated with (e.g., logged into) an application executing on a device operating in a user mode.

Example attributes of the standalone mode 126 include:
User context—in at least some implementations, when a standalone mode 126 is active on a device, the device does not operate based on a user context. For instance, in a standalone mode 126, no user profiles 134 are utilized for device operation.
Multiple standalone modes—multiple standalone modes 126 can be defined, such for different usage scenarios and/or usage contexts. For instance, different standalone modes 126 can be defined for different user roles, such as for different roles in an organization. Examples of different standalone modes 126 include “Corporate mode,” “Manager mode,” “Employee mode,” etc. In implementations, different standalone modes 126 can be associated with different permissions, such as data access permissions, device access permissions, and so forth. Further, particular users may be able to access different standalone modes 126, such as based on user permissions specified in respective user profiles 134.
Secured standalone modes—as mentioned above, multiple standalone modes 126 can be implemented. Thus, certain standalone modes may only be accessible to users with appropriate permissions. For instance, a particular user may be able to access a particular standalone mode with valid user authentication, and the standalone mode may operate without user context.

Example attributes of the schedule mode 128 include:
Time-based scheduling—different time-based schedules can be created for a device, such as monthly, weekly, daily, and/or hourly-based operation schedules. Further, different operation modes can be specified for particular schedule timeslots, such as whether a user mode 124 or a standalone mode 126 is active in a particular timeslot. Further, where multiple standalone modes 126 are available, a schedule can be created that specifies which standalone mode(s) are available in particular timeslots.
Time-based mode switching—schedules can be generated that enable automatic switching between different modes for different timeslots. For instance, a schedule mode 128 can be generated that switches between a user mode 124 and a standalone mode 126 at particular timeslots. Further, automatic switching between different standalone modes 126 can be specified for particular timeslots, such as to accommodate multipurpose facilities.
Schedule mode transitions—different behaviors can be specified for transitions between different modes, such as transitions between a user mode 124 and a standalone mode 126. For example, where a scheduled transition between a user mode 124 to standalone mode 126 occurs and a user is logged into a device in the user mode 124, options include:
   Remain in user mode 124 with current user authenticated, and transition to a standalone mode 126 when the user logs out and/or when the user times out due to lack of user activity, e.g., at an expiration of an activity timer.
   Present a notification t time period (e.g., t minutes, t seconds, etc.) before the scheduled mode transition and automatically log user out and transition to a standalone mode 126 when t expires. In implementations if an authenticated user is operating in a user mode 124 when an automated mode transition occurs, user data can be stored such as in a data storage location associated with the user's profile, such as before the device transitions from a user mode 124 to a standalone mode 126.
   Notify the user that a mode transition is scheduled to occur in t time period and enable the user to request additional time in the user mode. For instance, when a mode transition is scheduled to occur in t time period, a user interface can be presented that enables the user to request additional time in the user mode 124.

The user profiles 134 include different user-specific information, such as user identifiers, user contact data, user authentication data (e.g., passwords and/or other authentication factors), user permissions, user-specific operational settings, user preferences, and so forth. In at least some implementations, the device profile 206 can be associated with different user profiles 134 such that only specific user profiles 134 have permission to access the computing device 102. Further, different instances of user profiles 134 may have different permissions when the user profiles 134 are active (e.g., authenticated with) the computing device 102.

The browser behaviors 300 specify different network browser (e.g., web browser) behaviors for the computing device 102. In at least some implementations, different browser behaviors 300 may be specified for a standalone mode 126 and a user mode 124. Further, different user profiles 134 can include different browser behaviors 300.

Examples of different browser behaviors 300 include:
Home page—a home page can be specified for presentation on the computing device 102, such as a network-based page such as a webpage. Further, different home pages can be specified for a user mode 124 and a standalone mode 126, different user profiles 134 can be associated with different home pages, and/or different standalone modes 126 can be associated with different home pages.
Browser tab behaviors—different browser tab behaviors can be specified, such as which browser tab and/or tabs are presented on user authentication and/or device startup, whether a user (e.g., a particular user profile 134) is permitted to create new tabs, a limit on a number of tabs permitted to be created (if new tab creation is permitted), behaviors for when a selected link wants to create a new tab and/or a new window, etc.
Address bar—different address bar behaviors can be specified, such as whether an address bar is presented as part of a browser window, how a domain name and/or URL is presented in an address bar (if presented), if a user is permitted to access an address bar, and so forth. For instance, if a user (e.g., a user profile 134) is not permitted to access an address bar, the user may be prevented from entering a network address and/or a web address into the address bar. Further, address bar behaviors can be specified on a per-mode basis (e.g., separately for user modes 124 and standalone modes 126), and/or may be specified for different user profiles 134. For instance, different user profiles 134 may be associated with different respective address bar behaviors, e.g., may have different respective address bar settings and/or permissions.
Browser functions—access to different browser functions can be controlled on a per-device profile 206 basis, such as which browser buttons are presented and/or active. Examples of different browser functions/buttons that can be access controlled include a forward function, a back function, a refresh function, a bookmark function, a printer function, a logoff function, etc. Further different hotkeys can be enabled and/or disabled. For instance, a device profile 206 can specify which hotkeys are enabled and/or disabled.
Bookmarks—different browser bookmark behaviors can be specified, such as whether user bookmarking is allowed or disallowed, whether particular bookmarks are public (e.g., can be accessed by any authenticated user) or private, e.g., can only be accessed by particular authenticated users. In at least one implementation a device profile 206 can specify whether particular user profiles 134 are permitted to create and store bookmarks.
Network site (e.g., website) permissions—a device profile 206 can specify different permissions for different network sites, such as which network sites are allowed and/or disallowed for access by a browser. Examples of different network site permissions include:
   URLs can have advanced settings allowing an admin to further customize the experience. These fields can include setting whether or not a network site is muted, which can include header fields in a URL call and configuring the security settings of a network site.
   Specifying access permissions to particular domains, such as for particular home pages and/or tabs. Access permissions can also be specified for URLs will have advanced settings allowing the admin to further customize the experience. These fields include setting whether or not the website is muted, including header fields in the URL call and configuring the security settings of the website. In at least one implementation a third-party company can be utilized to categorize the websites. For instance, admin personnel can configure a profile to block websites categorized as adult & explicit sexual content, arms & ammunitions, crime & harmful acts, death, injury or military conflict, online piracy, hate speech, obscenity and profanity, illegal drugs/tobacco/e-cigarettes/vaping/alcohol, spam or harmful content, terrorism and/or sensitive social issues, etc.
   New content groups can be created and can be made public or private. For instance, public content groups can be accessible by multiple users (e.g., users associated with a device profile 206) and can be searchable by users with access permissions.
Logging behaviors—different network site access logging behaviors can be specified, such as which network sites were accessed, attempted to be accessed, access denied, etc. For denied network site accesses, reasons for access denial can be specified and/or stored.

The device permissions 302 can be used to specify which devices are accessible and/or not accessible when the device profile 206 is active and/or permission levels for accessible devices. Examples of such devices include printers (e.g., paper-based printers, 3D printers (e.g., additive printing devices), etc.), display devices, data storage devices and/or locations, cameras, microphones, etc. In at least some implementations the device permissions 302 enable permissions download to a single board computer such as to enable users to be limited to accessing an admin specified access to a particular limited set of network sites, e.g., a limited set of websites.

The network settings 304 represent settings that control access by the computing device 102 to various networks, such as the network 104. Examples of the network settings 304 include network names, passwords, IP addresses, etc. The network settings 304, for instance, enable device access to wired and/or wireless networks.

The auxiliary profiles 306 represent different device profiles that can be executed by the computing device 102 concurrently. For instance, multiple user profiles 134 can be concurrently active on the computing device 102. In at least one implementation where multiple user profiles 134 are concurrently active, the computing device 102 can provide selectable functionality (e.g., a GUI button, a hotkey, voice keyword, etc.) that enables switching between different active user profiles 134.

The auxiliary modes 308 represent different operation modes 122 that can be executed by the computing device 102 concurrently. For instance, multiple operation modes 122 (e.g., user mode 124, standalone mode 126, and/or schedule mode 128) can be concurrently active on the computing device 102. In at least one implementation where multiple operation modes 122 are concurrently active, the computing device 102 can provide selectable functionality (e.g., a GUI button, a hotkey, voice keyword, etc.) that enables switching between different active operation modes 122.

The profile theme 310 includes settings that specify different user experience features for the device profile 206, such as visual and audio attributes. The profile theme 310, for instance, can specify display aspects for the computing device 102 when the device profile 206 is active, such as a background color, tab color(s) (e.g., primary tab color, background tab color, etc.), text features such as default font and text color, and so forth. Further, the profile theme 310 can specify screensaver behaviors, such as a screensaver visual to be presented and a timeout period after which a screensaver can be displayed. For instance, after a t₁ time period without detecting user activity, a screensaver can be displayed.

The authentication settings 312 represent different authentication behaviors for the device profile 206. For instance, the authentication settings 312 can include permitted and/or supported authentication methods for authenticating with the computing device 102, such as passwords, physical authentication, biometric authentication, multifactor authentication, etc. Further, the authentication settings 312 can specify timeout settings, such as that after a t₂ time period without detecting user activity when a particular user profile 134 is active in a user mode 124, the computing device 102 can automatically log off the user profile 134. Further, a notification message can be displayed prior to the automatic log off the notify the user that the user will be automatically logged off in t₂ time period unless further user activity is detected.

The storage settings 314 can specify different data storage behaviors, such as whether users are permitted to store data associated with the computing device 102 and if so, where the data can be stored. In implementations where users are permitted to store data associated with the computing device 102 the storage settings 314 can specify parameters for the data storage, such as a maximum amount of data permitted to be stored (e.g., a maximum memory usage), a designated storage location for storing data, data types permitted to be stored, and so forth. For instance, for user profiles 134, the storage settings 314 can specify data storage locations associated with individual user profiles 134. Various types of data storage locations can be utilized, such as locally on the computing device 102 and/or remote data storage locations such as network drives and/or cloud-based storage. For instance, in a user mode 124, the storage settings 314 may enable the computing device 102 to access a user-specific remote data storage location to enable data operations such as retrieval of user data from and/or saving of user data to the remote data storage location.

In implementations a temporary home data storage location (e.g., home drive) can be created locally on the computing device 102 for a user while a user is interacting with the computing device, e.g., using a local storage location within the computing device 102. For instance, in a standalone mode 126 a temporary home drive can be created for temporary storage of data associated with user interactions. In a standalone mode 126, for example, the temporary home drive does not have a user context, e.g., is not associated with a user profile 134. In a user mode 124 a temporary user-specific home drive can be created for a user profile 134 that is authenticated with the computing device 102 and data associated with user interactions with the computing device 102 can be stored on the temporary user-specific home drive. Accordingly, whether in a standalone mode 126 or a user mode 124, the temporary home drive can be utilized for various data operations such for storage of downloaded files (e.g., if data downloads are permitted), viewing files, emailing files (e.g., if email functionality is enabled and permitted), and so forth.

In at least some implementations, whether in a standalone mode 126 or a user mode 124, when a user ends an interaction session with the computing device 102 (e.g., logs off), a temporary home drive created for the user is deleted, e.g., the temporary home drive instance is destroyed and/or data of the temporary home drive instance is automatically deleted.

Alternatively or additionally the storage settings 314 can specify that a user and/or specific user profiles 134 are permitted to attach an external data storage device (e.g., a USB drive, a peripheral data storage device, etc.) to a computing device 102. For instance, the external data storage device can be utilized as a user-specific home drive for the user while the user is interacting with the computing device 102, e.g., while the user profile 134 is logged into the computing device 102. This can enable the user to utilize the external data storage device for various purposes, such as to utilize the computing device 102 to interact with files stored on the external data storage device, and to perform file operations on files such as to create, edit, delete, move, copy, rename, and/or email files stored on the external data storage device.

The group settings 316 represent settings for generating different device groups and user groups. For instance, device groups can be generated that are associated with different device profiles 206 and thus can inherit the various settings and configurations associated with respective device profiles 206. For instance, when a user such as an admin initially configures and/or reconfigures the computing device 102, the user can associate the computing device 102 with a particular device group. Thus, device settings (e.g., based on a device profile 206) for the particular device group can be automatically applied to the device.

Additionally or alternatively, the groups settings 316 can include user groups that are generated to include different user profiles 134. For instance, different sets of device settings (e.g., permissions) can be associated with different user groups, and can be applied to user profiles 134 placed within the respective user groups. Further, a particular user profile 134 may be associated with different user groups. For instance, when a particular user group is applied to a particular device, the settings for the user group can be applied to a user profile 134 within the user group.

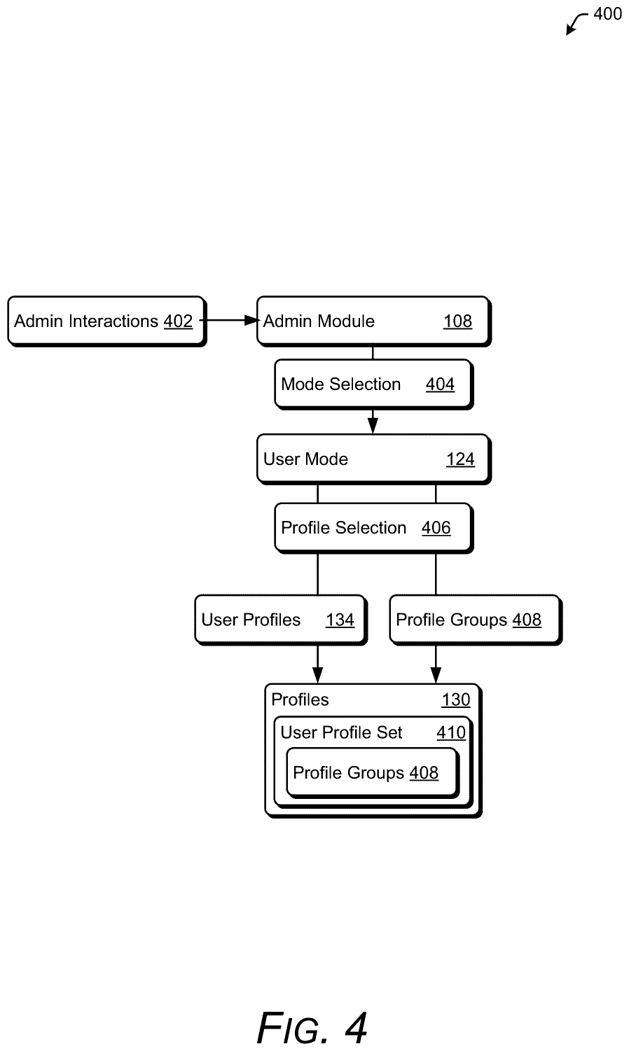

FIG. 4 depicts an example system 400 that supports implementations for operation modes for a computing device. The system 400, for example, can be implemented in the context of the environment 100 and can incorporate attributes of the system 200. The system 400, for instance, represents an additional or alternative implementation to the system 200.

In the system 400, admin interactions 402 are received to the admin module 108 to configure operational settings of the computing device 102. The admin interactions 402, for instance, are generated via user input to the computing device 102, such as by an admin personnel. As part of the admin interactions 402 a mode selection 404 is received to select an operation mode 122 for operation of the computing device 102. In this particular example the mode selection 404 selects the user mode 124 as introduced above. Accordingly, the admin interactions 402 further include profile selection 406 for selecting user profiles to utilize as part of the user mode 124. The profile selection 406 can be implemented in various ways, such as via selection of individual user profiles 134 and/or via selection of one or more profile groups 408. The profile groups 408, for example, represent groups of user profiles 134. The profile groups 408 can be generated in different ways, such as based on user profiles 134 associated with particular organizations, user profiles 134 associated with particular organizational roles, user profiles 134 associated with particular permissions, and so forth.

Accordingly, based on the profile selection 406, a user profile set 410 is generated for the profiles 130. The user profile set 410 represents user profiles 134 that are permitted to access (e.g., authenticate with) the computing device 102. In an optional implementation, the user profile set 410 includes one or more profile groups 408.

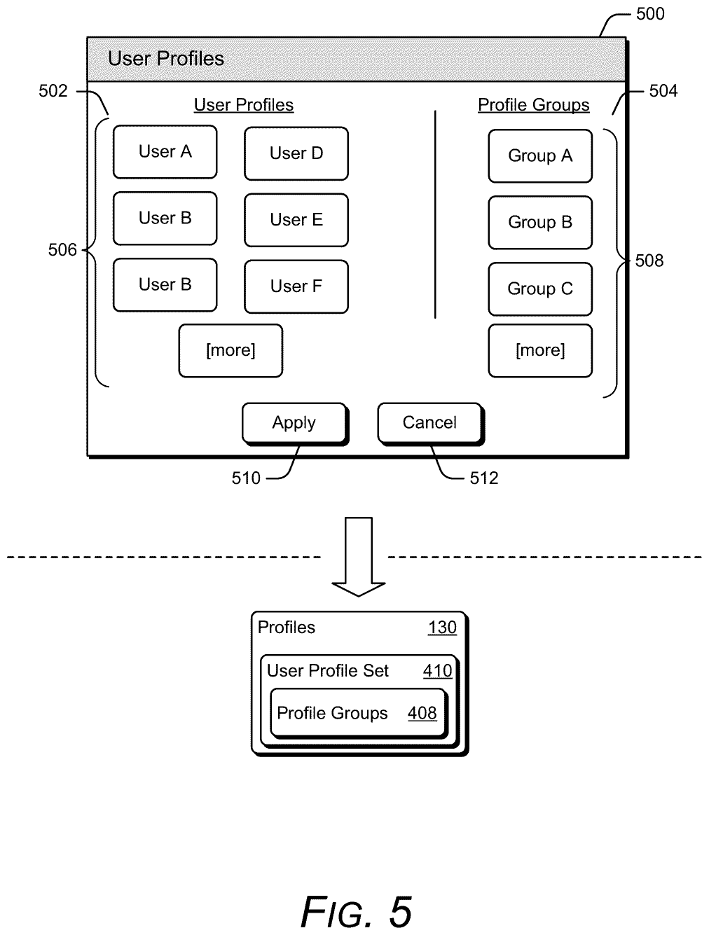

FIG. 5 depicts an example profile GUI 500 that supports implementations for operation modes for a computing device. In at least one implementation the profile GUI 500 is implemented in conjunction with the system 400. The profile GUI 500, for example, is presented to enable the profile selection 406 as part of configuration of the user mode 124, such as in response to the mode selection 404 to select the user mode 124.

The profile GUI 500 enables selection of user profiles 134 to be associated with the computing device 102 and includes a user profiles region 502 and a profile groups region 504. The user profiles region 502 includes different selectable indicia 506 that each represent a different respective instance of a user profile 134. The selectable indicia 506, for instance, each identify an instance of a user profile 134, such as based on a username and/or other user identifier. The profile groups region 504 includes different selectable indicia 508 that each represent a respective instance of a profile group 408 and may include an identifier for a respective profile group name. Accordingly, a user may interact with the selectable indicia 506 to select individual user profiles 134 and may interact with the selectable indicia 508 to select individual profile groups 408.

The profile GUI 500 further includes an apply control 510 and a cancel control 512. The apply control 510 is selectable to apply selected user profiles 134 from the user profiles region 502 and/or selected profile groups 408 from the profile groups region 504 to the profiles 130, e.g., to generate the user profile set 410. The cancel control 512 is selectable to cancel profile selections from the profile GUI 500 and/or to cause the profile GUI 500 to be canceled and removed from display.

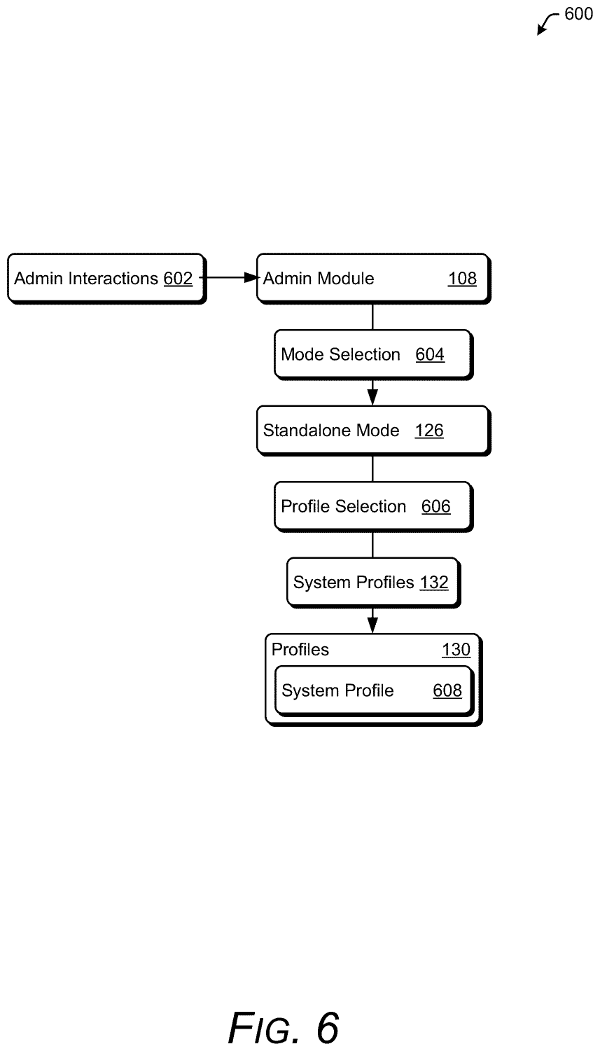

FIG. 6 depicts an example system 600 that supports implementations for operation modes for a computing device. The system 600, for example, can be implemented in the context of the environment 100 and can incorporate attributes of the systems 200, 400. The system 600, for instance, represents an additional or alternative implementation to the systems 200, 400.

In the system 600, admin interactions 602 are received to the admin module 108 to configure operational settings of the computing device 102. The admin interactions 602, for instance, are generated via user input to the computing device 102, such as by an admin personnel. As part of the admin interactions 602 a mode selection 604 is received to select an operation mode 122 for operation of the computing device 102. In this particular example the mode selection 604 selects the standalone mode 126 as introduced above.

Accordingly, based on selection of the standalone mode 126, the admin interactions 602 further include profile selection 606 to select a system profile 608 from the system profiles 132. The system profile 608, for instance, includes different device configuration settings for configuring operation of the computing device 102 in a standalone mode 126. Examples of different configuration settings that can be included in the system profile are discussed with reference to the device profile 206. The system profile 608, for instance, can specify different browser behaviors 300, device permissions 302, auxiliary profiles 306, auxiliary modes 308, a profile theme 310, storage settings 314, group settings 316, and so forth, that are applied in the standalone mode 126 for the system profile 608. These examples of configuration settings for the system profile 608 are presented for purpose of example only, and it is to be appreciated that at a variety of different configuration settings are applicable for the system profile 608 within the scope of the implementations described and claimed herein. As just one example, a profile theme 310 for the system profile 608 specifies different visual and/or audio attributes for user interface elements (e.g., GUI elements) that are presented in the standalone mode 126.

While the system 600 is discussed with reference to selection of a single system profile 608, it is to be appreciated that multiple system profiles 132 can be selected and utilized in a standalone mode 126. For instance, where multiple system profiles 132 are available in the standalone mode 126, which particular system profile 132 is active during a particular user interaction with the computing device 102 in the standalone mode 126 can be based on a variety of different factors, such as an identity of a user interacting with the computing device 102 (e.g., based on user authentication using a user profile 134), a location of the computing device 102 (e.g., physical location such as a region of a facility and/or geographical location), an operation schedule generated for the computing device 102, and so forth.

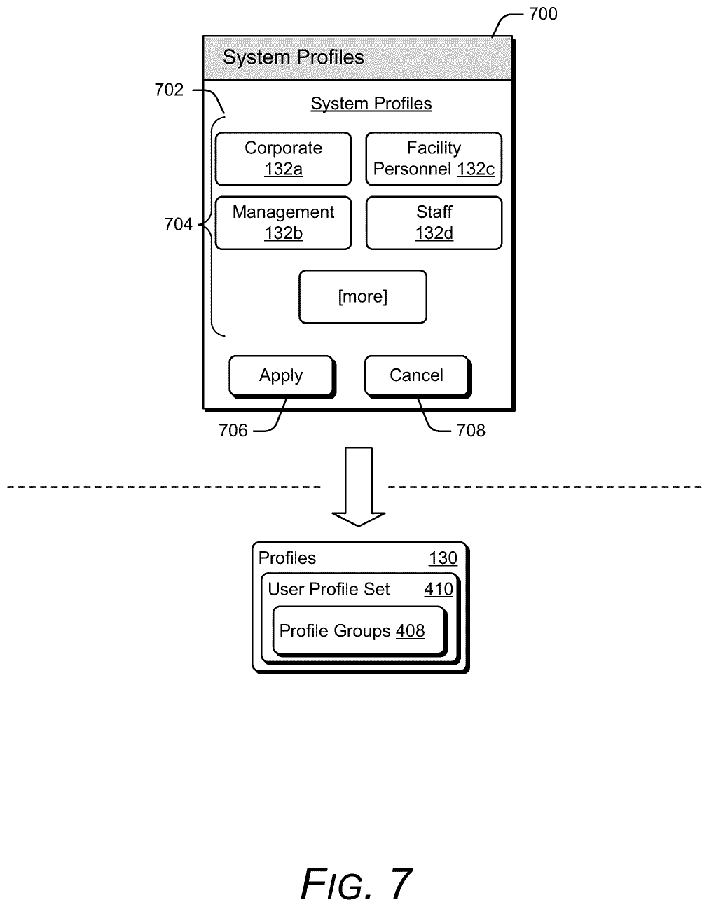

FIG. 7 depicts an example system profile GUI 700 that supports implementations for operation modes for a computing device. In at least one implementation the system profile GUI 700 is implemented in conjunction with the system 600. The system profile GUI 700, for example, is presented to enable the profile selection 606 as part of configuration of the standalone mode 126, such as in response to the mode selection 604 to select the standalone mode 126.

The system profile GUI 700 enables selection of system profiles 132 to be associated with the computing device 102 and includes a system profiles region 702. The system profiles region 702 includes different selectable indicia 704 that each represent a different respective instance of a system profile 132. The selectable indicia 704, for instance, each identify an instance of a system profile 132, such as based on a profile name and/or other profile identifier. Accordingly, a user may interact with the selectable indicia 704 to select individual system profile 132 and/or set of system profiles 132. In this particular example, the system profiles 132 include a corporate system profile 132a, a management system profile 132b, a facility personnel system profile 132c, and a staff system profile 132d. These examples are presented for purpose of illustration only, and a wide variety of different types and instances of system profiles 132 can be implemented in accordance with the disclosed implementations.

The profile GUI 700 further includes an apply control 706 and a cancel control 708. The apply control 706 is selectable to apply a selected system profile 132 and/or set of system profiles 132 from the system profiles region 702 to apply the selected system profile(s) to the profiles 130. The cancel control 708 is selectable to cancel profile selections from the profile GUI 700 and/or to cause the profile GUI 700 to be canceled and removed from display.

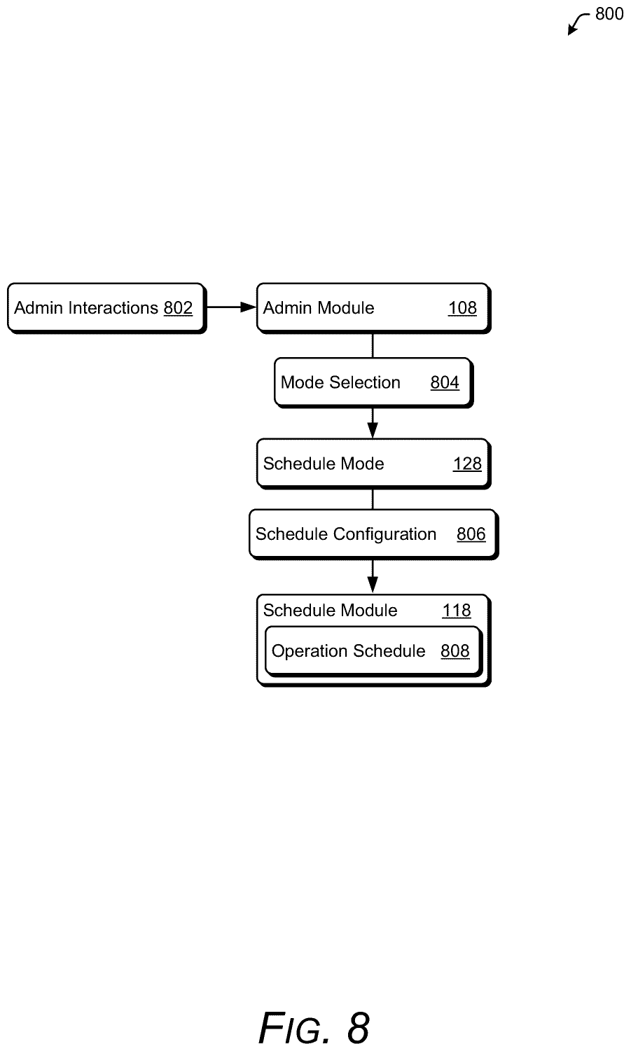

FIG. 8 depicts an example system 800 that supports implementations for operation modes for a computing device. The system 800, for example, can be implemented in the context of the environment 100 and can incorporate attributes of the systems 200, 400, 600.

In the system 800, admin interactions 802 are received to the admin module 108 to configure operational settings of the computing device 102. The admin interactions 802, for instance, are generated via user input to the computing device 102, such as by an admin personnel. Alternatively or additionally, the admin interactions 802 can include input to the system server 120, such as to the system settings module 138 and/or the system profiles module 140. As part of the admin interactions 802 a mode selection 804 is received to select an operation mode 122 for operation of the computing device 102. In this particular example the mode selection 804 selects the schedule mode 128 as introduced above.

Accordingly, based on selection of the schedule mode 128, the admin interactions 802 further include schedule configuration 806 to configure an operation schedule 808 for operation of the computing device 102. The operation schedule 808, for instance, represents an instance of the operation schedules 136 and can specify different time-based behaviors, such as what modes (e.g., a standalone mode 126 and/or a user mode 124) are active at a particular time, times at which a mode transition is to occur, times at which the computing device 102 is to be automatically powered on and/or powered off, permissions that apply at particular times, and so forth. As used herein, the term “time” can refer to a variety of different time-based parameters, such as times of day, days of the week, months, calendar dates, timer values, and combinations thereof.

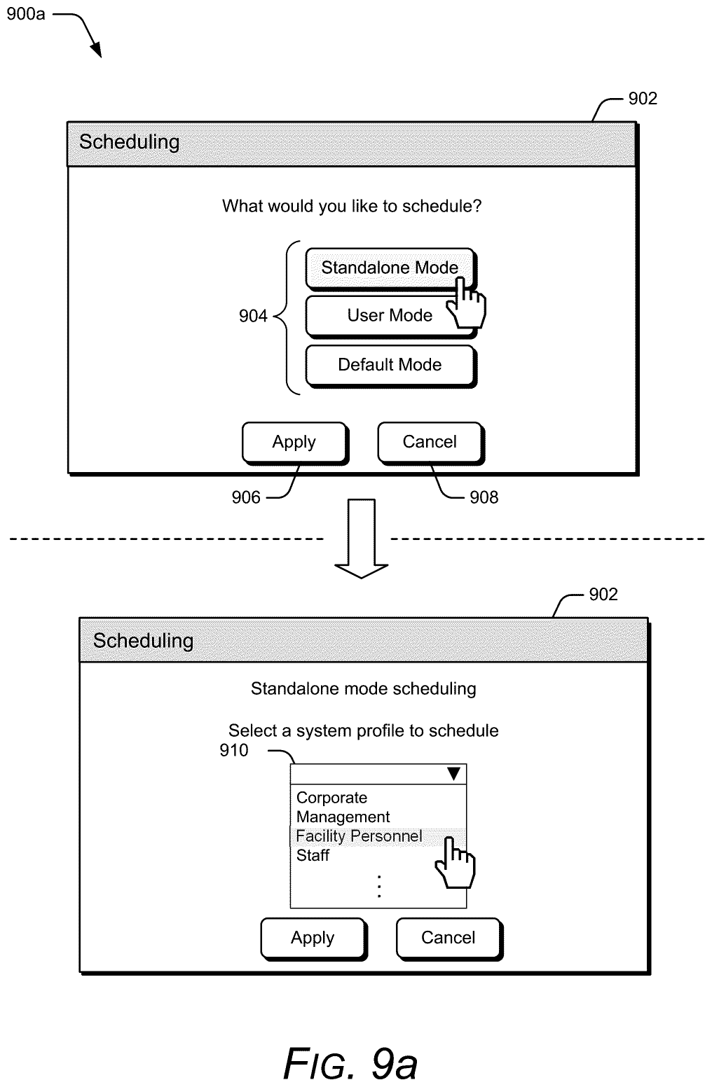

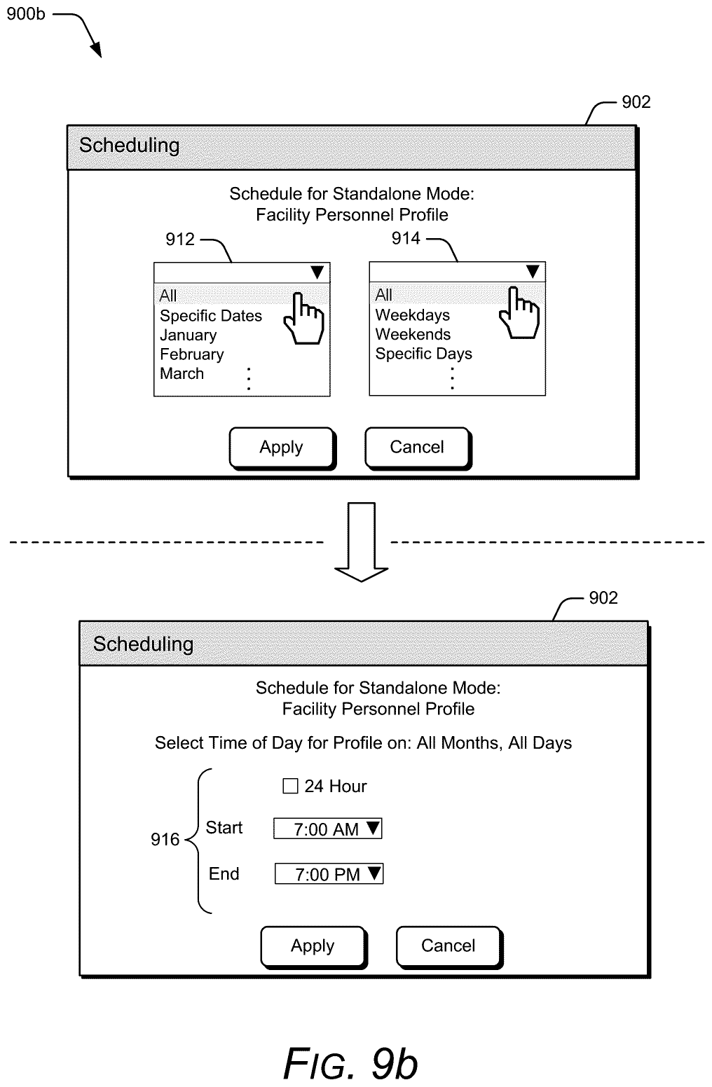

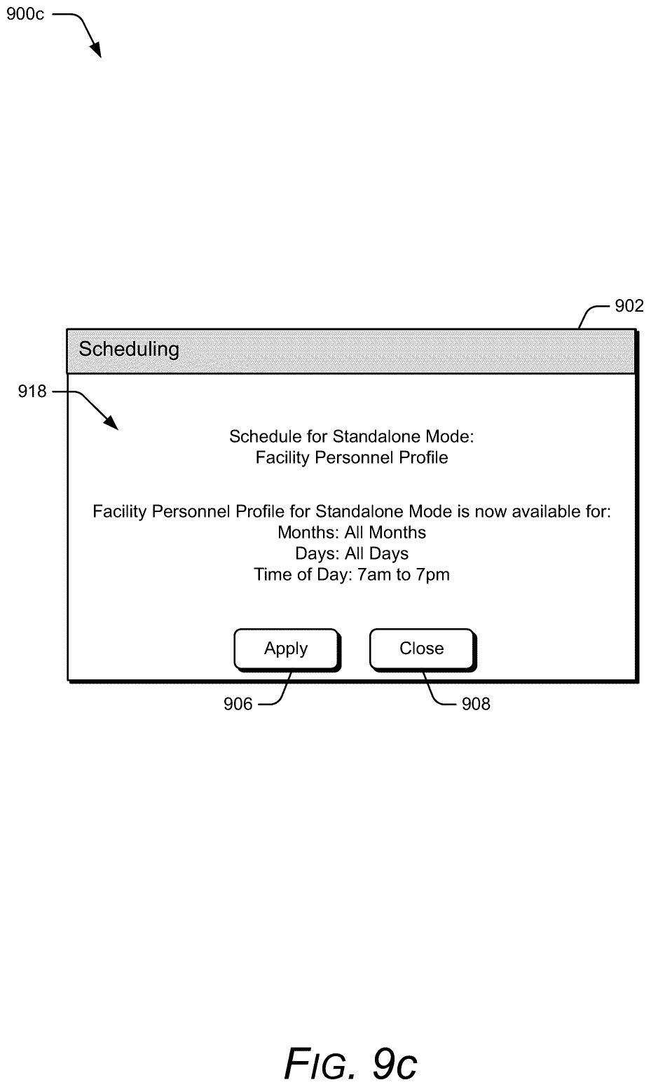

FIG. 9a depicts an example scenario 900a for configuring scheduling in accordance with implementations for operation modes for a computing device. In at least one implementation the scenario 900a is implemented in conjunction with the system 800. The scenario 900a includes a schedule GUI 902 that enables a user to select an operation mode 122 to be scheduled. Further, the schedule GUI 902 includes mode indicia 904, an apply control 906, and a cancel control 908. The mode indicia 904 are each associated with a different operation mode 122 and are each selectable to select a particular operation mode 122 for scheduling. The apply control 906 is selectable to apply settings from the schedule GUI 902 to the operation schedules 136 and the cancel control 908 is selectable to cancel profile selections from the profile GUI 902 and/or to cause the schedule GUI 902 to be canceled and removed from display.

Further to the scenario 900a, a user selects the standalone mode 126 and a profile selection menu 910 is presented in the schedule GUI 902 that presents different system profiles 132 for selection and scheduling. In this particular example a “Facility Personnel” system profile 132 is selected for scheduling.

FIG. 9b depicts an example scenario 900b for configuring scheduling in accordance with implementations for operation modes for a computing device. The scenario 900b, for instance, represents a continuation of the scenario 900a. In the scenario 900b, the schedule GUI 902 is populated with a date menu 912 and a day menu 914. The date menu 912 enables selection of particular dates for scheduling, such as particular months and/or specific date ranges, such as sets of dates within particular months. The day menu 914 enables particular days of the week to be selected for scheduling. In this particular example “All” dates are selected from the date menu 912, e.g., indicating that the scheduling is to be applied to all months, e.g., year round. Further, “All” days are selected from the day menu, e.g., indicating that the scheduling is to be applied to all days, e.g., to every day of the week.

Continuing with the scenario 900b, a time of day menu 916 is presented in the schedule GUI 902 that enables selection of a time range in which the specified scheduling is to be applied. For instance, a user can select a “24 hour” option to apply the scheduling all day and can specify a particular time range for which to apply scheduling. In this particular example a user interacts with the time of day menu 916 to specify a time range of 7:00 am to 7:00 pm.

FIG. 9c depicts an example scenario 900c for configuring scheduling in accordance with implementations for operation modes for a computing device. The scenario 900c, for instance, represents a continuation of the scenarios 900a, 900b. In the scenario 900c an overview 918 of the scheduling parameters specified in the scenarios 900a, 900b is presented in the schedule GUI 902. The overview 918, for instance, specifies that scheduling is specified for the “Standalone Mode,” “Facility Personnel Profile” for all months, all days, and for 7:00 am to 7:00 pm. The apply control 906 can then be selected to apply the specified scheduling, e.g., to generate an operation schedule 136 for operation of the computing device 102. Alternatively the cancel control 908 can be selected to cancel the specified scheduling parameters.

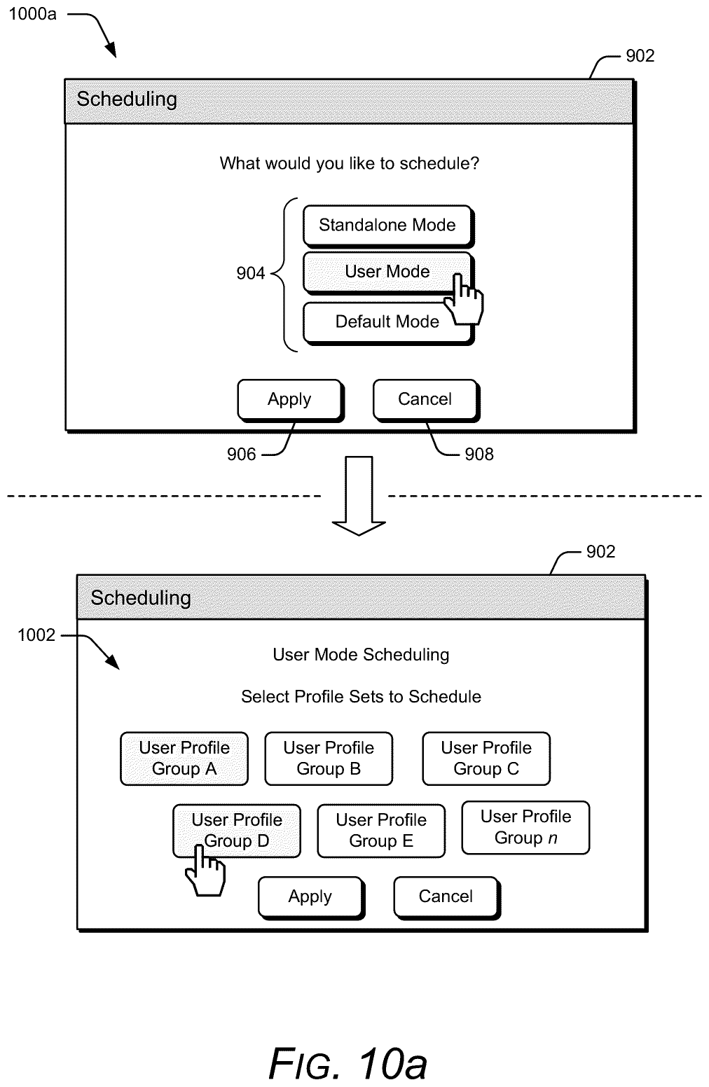

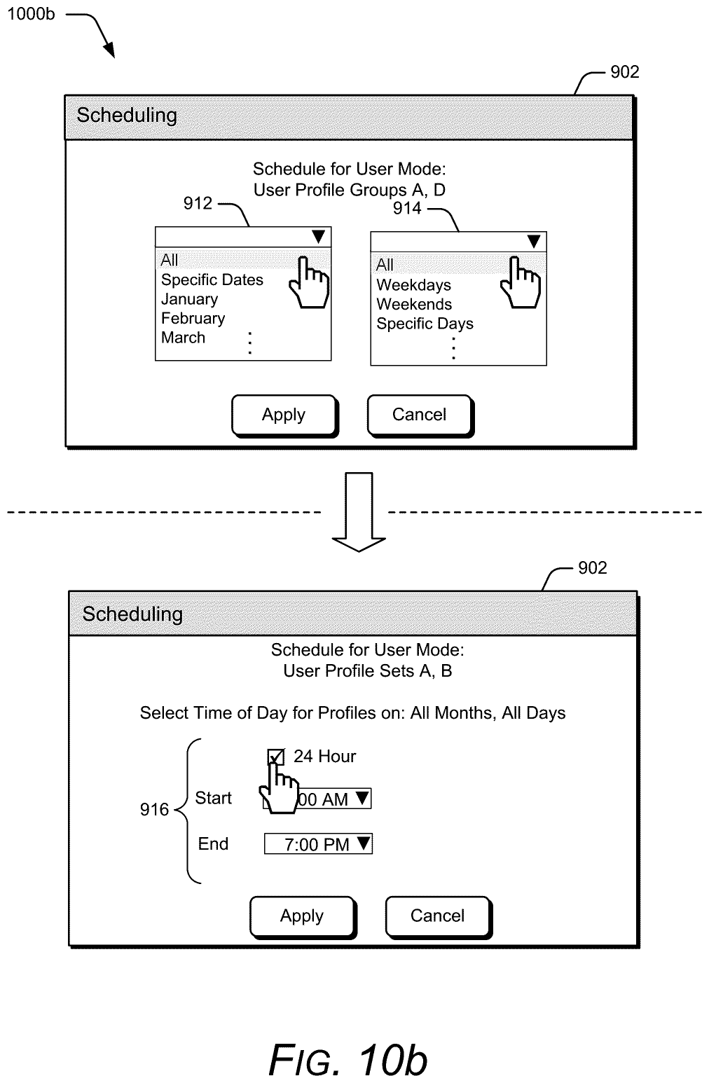

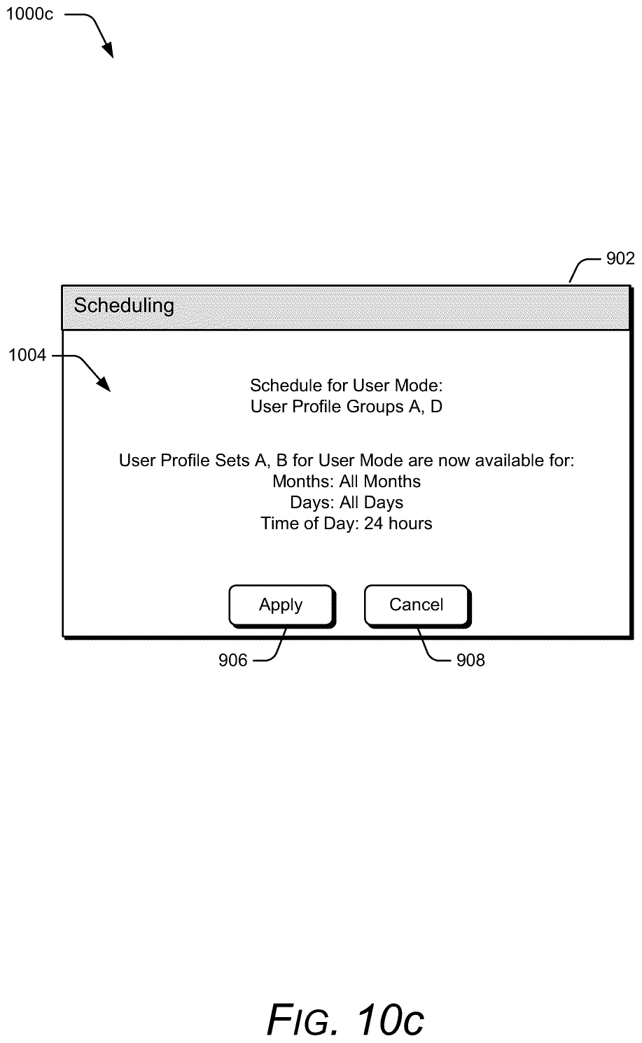

FIG. 10a depicts an example scenario 1000a for configuring scheduling in accordance with implementations for operation modes for a computing device. In at least one implementation the scenario 1000a is implemented in conjunction with the system 800. The scenario 1000a includes the schedule GUI 902 introduced above. In the scenario 1000a a user selects the user mode 124 from the mode indicia 904 and user profile group indicia 1002 are presented in the schedule GUI 902. Each of the user profile group indicia 1002 is selectable to select a corresponding set of user profiles 134 for scheduling. Each user profile group indicia 1002, for instance, is associated with a specified group of user profiles 134. Groups of user profiles 134, for instance, can be generated such as via interaction with the profile module 116 and/or the system profiles module 140.

Continuing with the scenario 1000a, a user selects instances of the user profile group indicia 1002, e.g., a “User Profile Group A” and a “User Profile Group D” for scheduling according to the user mode 124.

FIG. 10b depicts an example scenario 1000b for configuring scheduling in accordance with implementations for operation modes for a computing device. The scenario 1000b, for instance, represents a continuation of the scenario 1000a. In the scenario 1000b, the schedule GUI 902 is populated with the date menu 912 and the day menu 914. In this particular example “All” dates are selected from the date menu 912, e.g., indicating that the scheduling is to be applied to all months, e.g., year round. Further, “All” days are selected from the day menu, e.g., indicating that the scheduling is to be applied to all days, e.g., to every day of the week.

Further to the scenario 1000b the time of day menu 916 is presented in the schedule GUI 902 and a user selects a “24 hour” option to apply the scheduling all day.

FIG. 10c depicts an example scenario 1000c for configuring scheduling in accordance with implementations for operation modes for a computing device. The scenario 1000c, for instance, represents a continuation of the scenarios 1000a, 1000b. In the scenario 1000c an overview 1004 of the scheduling parameters specified in the scenarios 1000a, 1000b is presented in the schedule GUI 902. The overview 1004, for instance, specifies that scheduling is specified for the “User Mode” is to be applied for User Profile Groups A, D for all months, all days, and 24 hours a day. The apply control 906 can then be selected to apply the specified scheduling, e.g., to generate an operation schedule 136 for operation of the computing device 102. Alternatively the cancel control 908 can be selected to cancel the specified scheduling parameters.

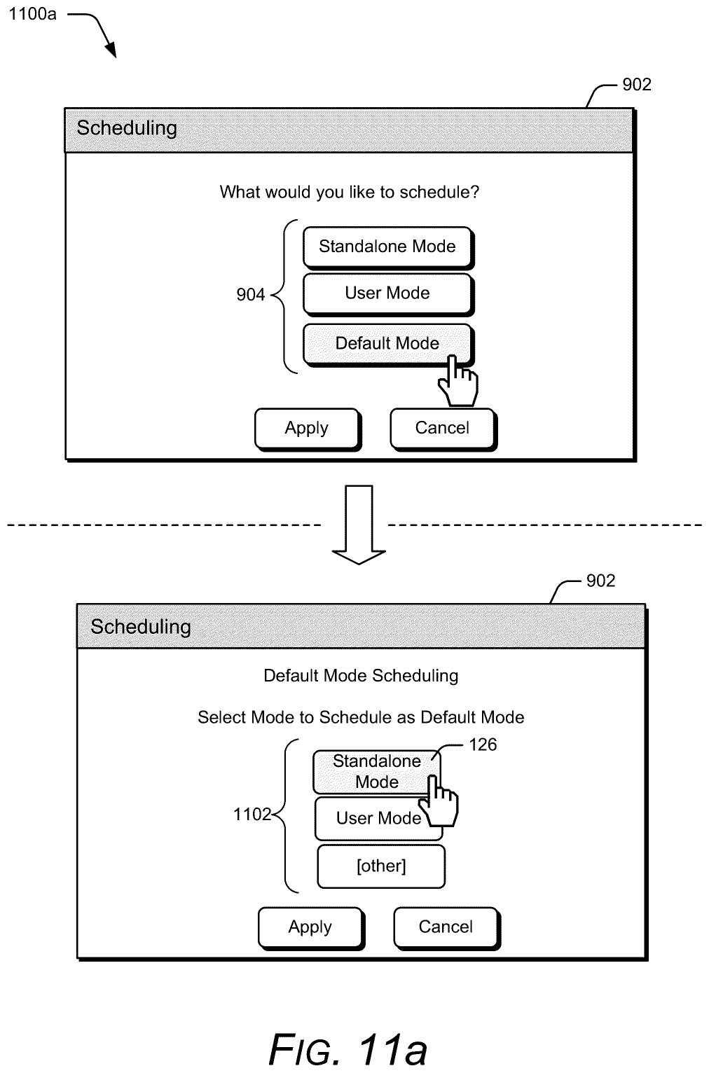

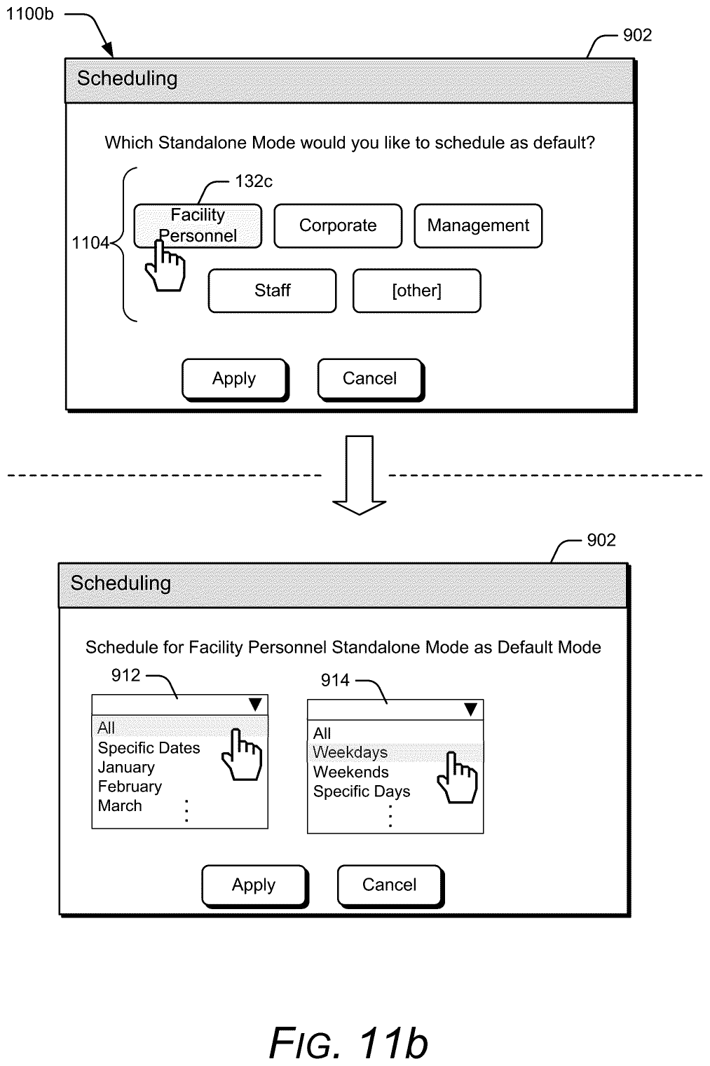

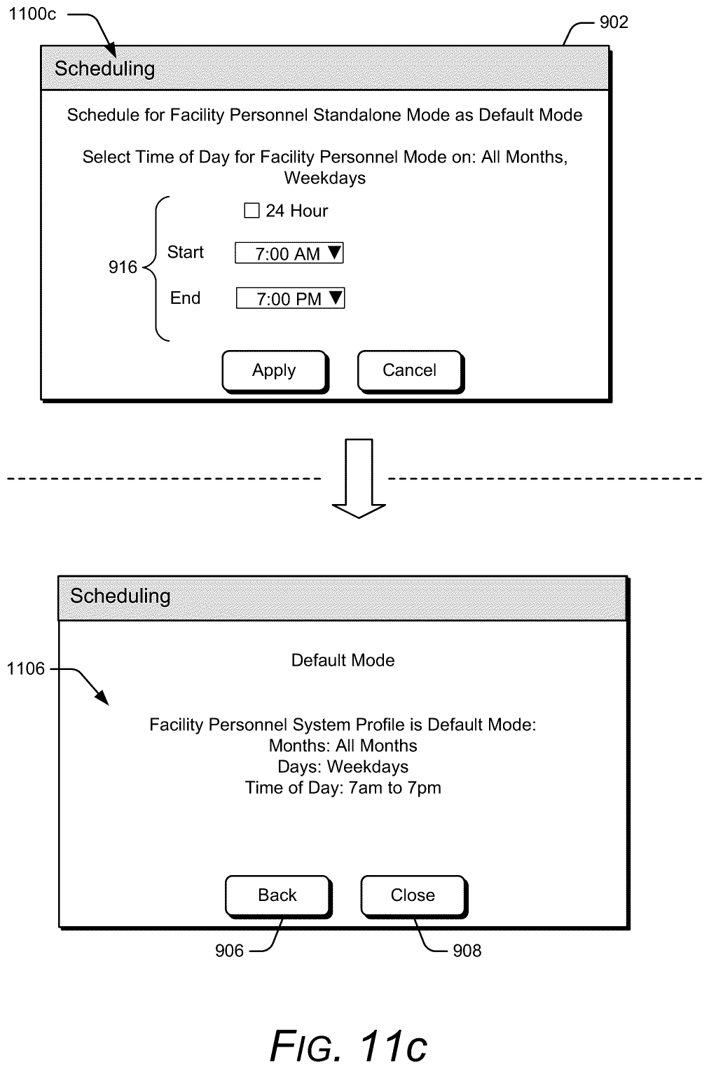

FIG. 11a depicts an example scenario 1100a for configuring scheduling in accordance with implementations for operation modes for a computing device. In at least one implementation the scenario 1100a is implemented in conjunction with the system 800. The scenario 1100a includes the schedule GUI 902 introduced above. In the scenario 1100a a user selects the default mode 129 from the mode indicia 904 for scheduling. Accordingly, default mode indicia 1102 are presented in the schedule GUI 902. The default mode indicia 1102, for instance, include indicia for different operation modes 122 that are selectable for specifying a particular default operation mode 122 for operation of the computing device 102. In this particular example a user selects the standalone mode 126.

FIG. 11b depicts an example scenario 1100b for configuring scheduling in accordance with implementations for operation modes for a computing device. The scenario 1100b, for instance, represents a continuation of the scenario 1100a. In the scenario 1100b the schedule GUI 902 is populated with profile indicia 1104 that are each selectable to select a particular system profile 132 to schedule as a default standalone mode for the computing device 102. In this particular example the facility personnel system profile 132c is selected to be scheduled as a default standalone mode.

Continuing with the scenario 1100b, the schedule GUI 902 is populated with the date menu 912 and the day menu 914. In this particular example “All” dates are selected from the date menu 912, e.g., indicating that the scheduling is to be applied to all months, e.g., year round. Further, “Weekdays” days are selected from the day menu, e.g., indicating that the scheduling is to be applied to weekdays, e.g., Monday-Friday.

FIG. 11c depicts an example scenario 1100c for configuring scheduling in accordance with implementations for operation modes for a computing device. The scenario 1100c, for instance, represents a continuation of the scenarios 1100a, 1100b. In the scenario 1100c the time of day menu 916 is presented in the schedule GUI 902 and a user selects a 7:00 am to 7:00 pm option to apply the scheduling to the 7:00 am to 7:00 pm timeslot.

Continuing with the scenario 1100c an overview 1106 of the scheduling parameters specified in the scenarios 1100a-1100c is presented in the schedule GUI 902. The overview 1106, for instance, specifies that the facility personnel system profile is a default mode for all months, weekdays, and for the time slot of 7 am to 7 pm. The apply control 906 can then be selected to apply the specified scheduling, e.g., to generate an operation schedule 136 for operation of the computing device 102. Alternatively the cancel control 908 can be selected to cancel the specified scheduling parameters.

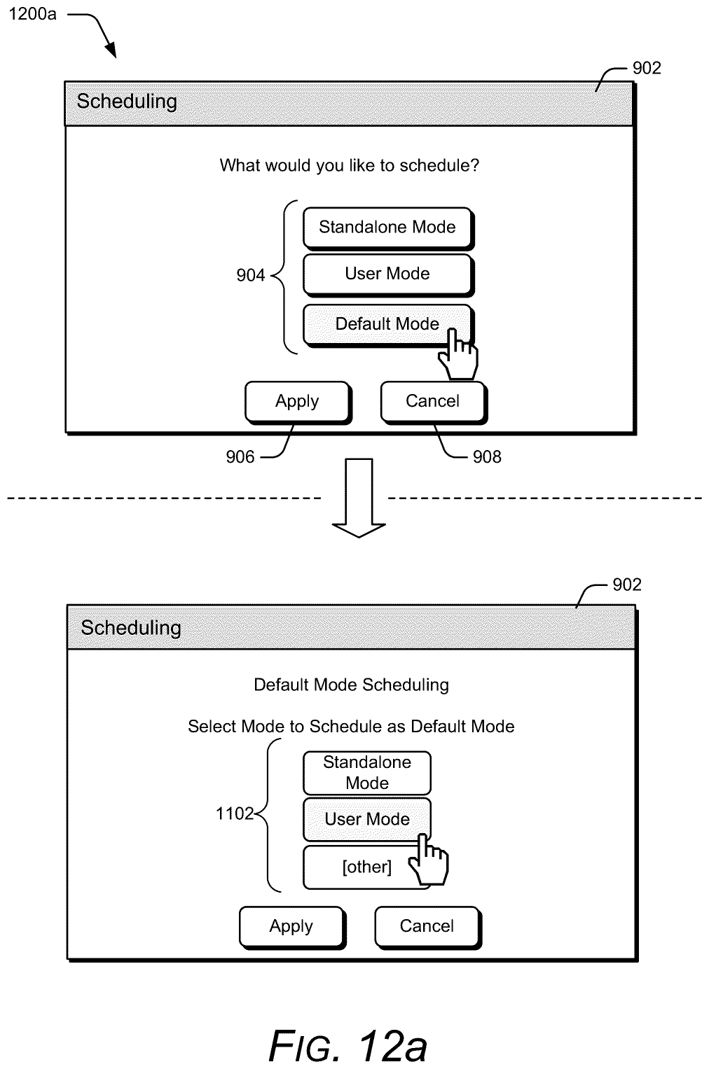

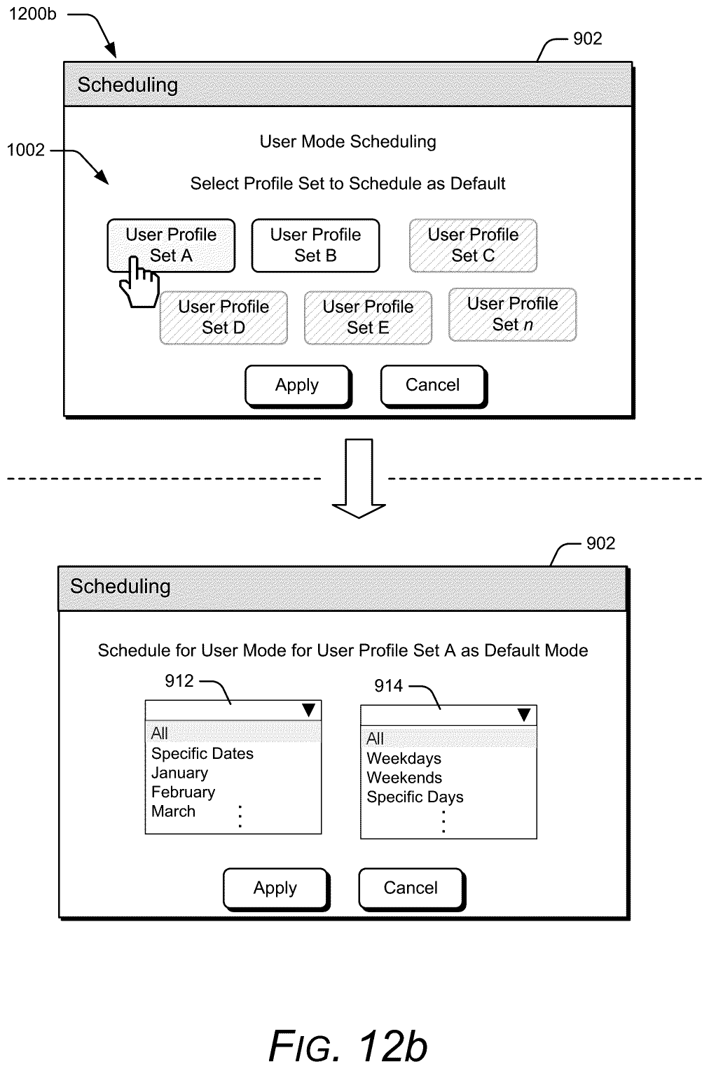

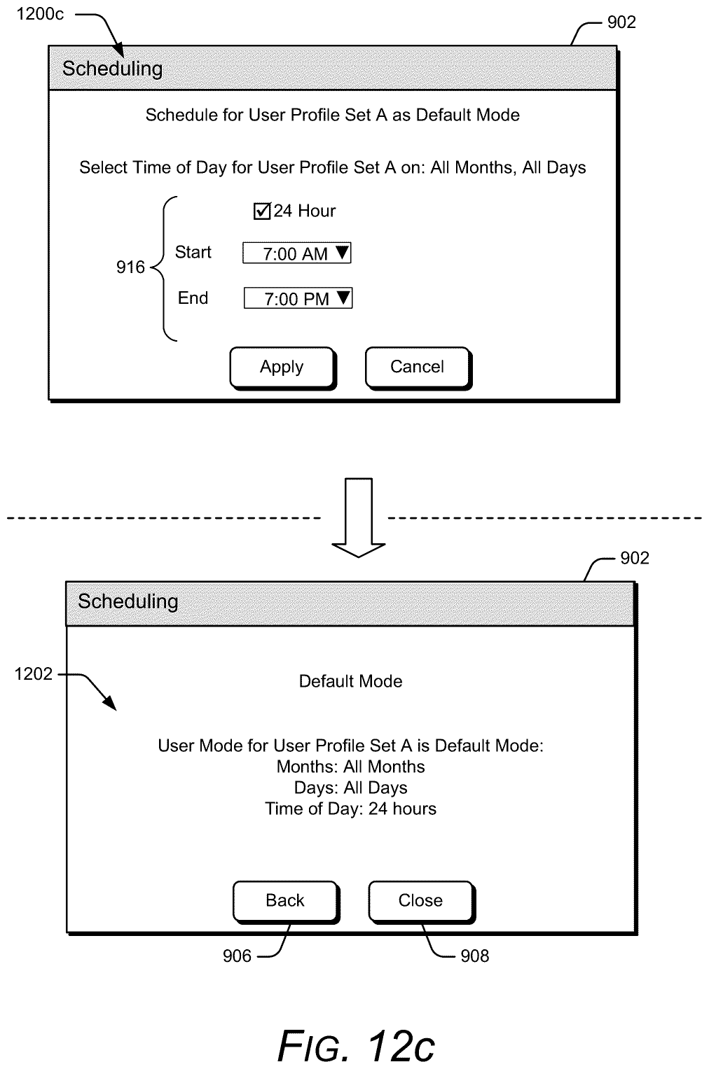

FIG. 12a depicts an example scenario 1200a for configuring scheduling in accordance with implementations for operation modes for a computing device. In at least one implementation the scenario 1200a is implemented in conjunction with the system 800. The scenario 1200a includes the schedule GUI 902 introduced above. In the scenario 1200a a user selects the default mode 129 from the mode indicia 904 for scheduling. Accordingly, the default mode indicia 1102 are presented in the schedule GUI 902. In this particular example a user selects the user mode 124 from the mode indicia 904.

FIG. 12b depicts an example scenario 1200b for configuring scheduling in accordance with implementations for operation modes for a computing device. The scenario 1200b, for instance, represents a continuation of the scenario 1200a. In the scenario 1200b the schedule GUI 902 is populated with the user profile group indicia 1002 that are each selectable to select a particular set of user profiles 134 to schedule as a default user mode for the computing device 102. Notice that in this particular implementation some of the user profile group indicia 1002 are “greyed out” to indicate that the particular user profile group indicia are not selectable to be scheduled as a default user mode. For instance, the User Profile Sets C, D, E, and n are visually deemphasized to indicate that these user profile sets are not available for scheduling as a default user mode. Various factors can cause a user profile set to be unavailable for scheduling as a default user mode, such as a permissions setting indicating that the user profile set is unavailable for scheduling as a default user mode, an admin personnel marking the user profile set as being unavailable for a default user mode, a behavior attribute (e.g., a user mode 124 attribute) of the user profile set being incompatible with default user mode functionality, and so forth.

In this particular example the User Profile Set A is selected to be scheduled as a default user mode. Accordingly, the schedule GUI 902 is populated with the date menu 912 and the day menu 914. In this particular example “All” dates are selected from the date menu 912, e.g., indicating that the scheduling is to be applied to all months, e.g., year round. Further, “All” days are selected from the day menu, e.g., indicating that the scheduling is to be applied to all days of the week.

FIG. 12c depicts an example scenario 1200c for configuring scheduling in accordance with implementations for operation modes for a computing device. The scenario 1200c, for instance, represents a continuation of the scenarios 1200a, 1200b. In the scenario 1200c the time of day menu 916 is presented in the schedule GUI 902 and a user selects the 24 Hour option to apply the scheduling to entire 24 hour periods.

Continuing with the scenario 1200c an overview 1202 of the scheduling parameters specified in the scenarios 1200a-1200c is presented in the schedule GUI 902. The overview 1202, for instance, specifies that a user mode for the User Profile Set A is a default mode for the computing device 102 for all months, all days, and 24 hours a day. The apply control 906 can then be selected to apply the specified scheduling, e.g., to generate an operation schedule 136 for operation of the computing device 102. Alternatively the cancel control 908 can be selected to cancel the specified scheduling parameters.

Consider now some example procedures for operation modes for a computing device in accordance with one or more implementations. The procedures may be performed in various ways, such as by computing device 102, the system server 120, and/or cooperatively between the computing device 102 and the system server 120.

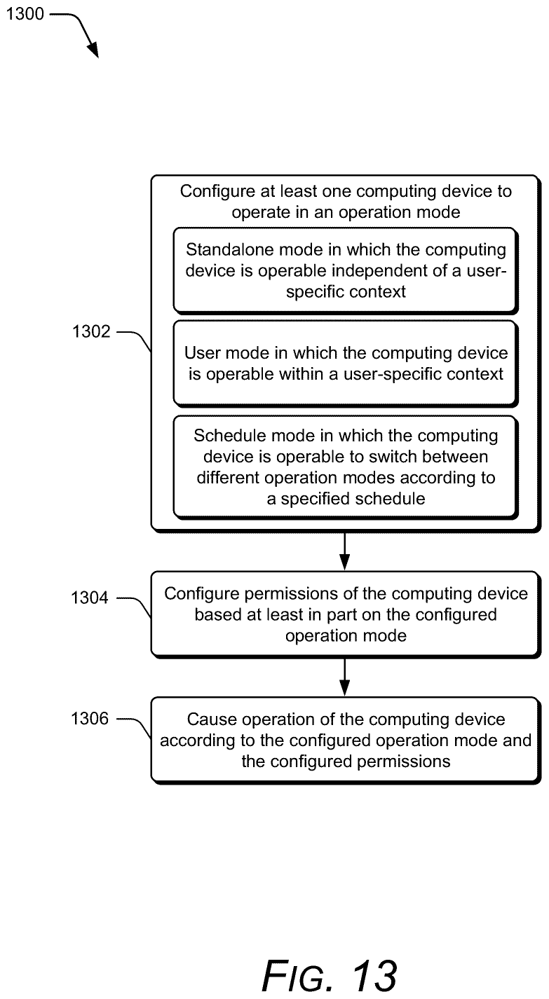

FIG. 13 depicts a method 1300 for operation modes for a computing device in accordance with one or more implementations. At 1302 a computing device is configured to operate in an operation mode. The operation mode, for instance, is selected from a standalone mode in which the computing device is operable independent of a user-specific context; a user mode in which the computing device is operable within a user-specific context; and a schedule mode in which the computing device is operable to switch between different operation modes according to a specified schedule. Example attributes of the different operation modes are detailed above.

At 1304 permissions of the computing device are configured based at least in part on the configured operation mode. For instance, different operation modes are associated with different types and/or instances of permissions. At 1306 operation of the computing device is caused according to the configured operation mode and the configured permissions. The computing device, for example, is deployed and operated according to a particular operation mode and/or set of operation modes, and according to permissions specified for the computing device. The permissions, for instance, are based on a particular operation mode and/or set of operation modes.

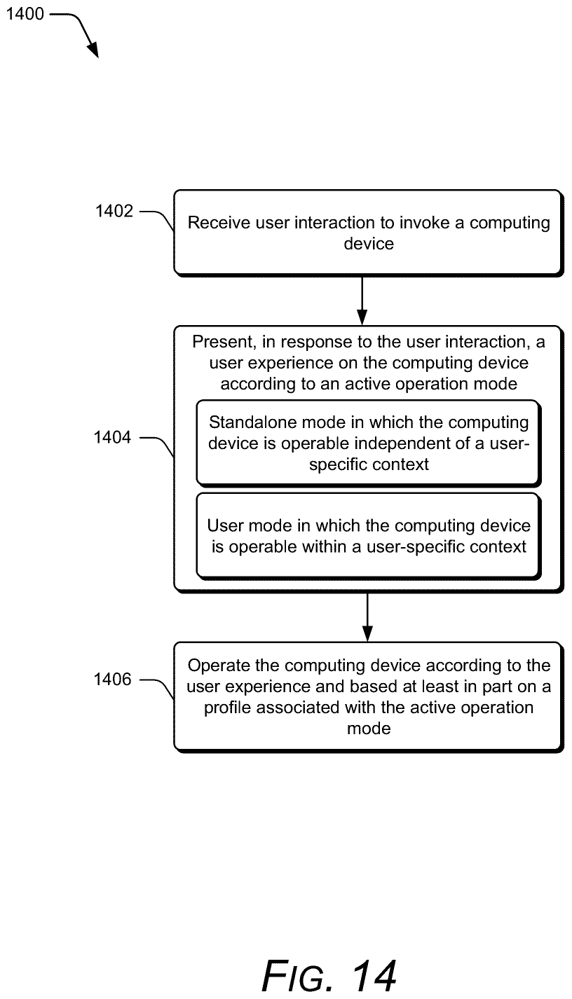

FIG. 14 depicts a method 1400 for operation modes for a computing device in accordance with one or more implementations. At 1402 user interaction is received to invoke a computing device. At 1404, in response to the user interaction, a user experience is presented on the computing device according to an active operation mode. In implementations, the active operation is selected from operation modes including a standalone mode in which the computing device is operable independent of a user-specific context, and a user mode in which the computing device is operable within a user-specific context. The user experience, for example, is based on various settings for the active operation mode, examples of which are detailed above.

At 1406 the computing device is operated according to the user experience and based at least in part on a profile associated with the active operation mode. The profile, for instance, represents a user profile (e.g., in a user mode) or a system profile, e.g., in a standalone mode.

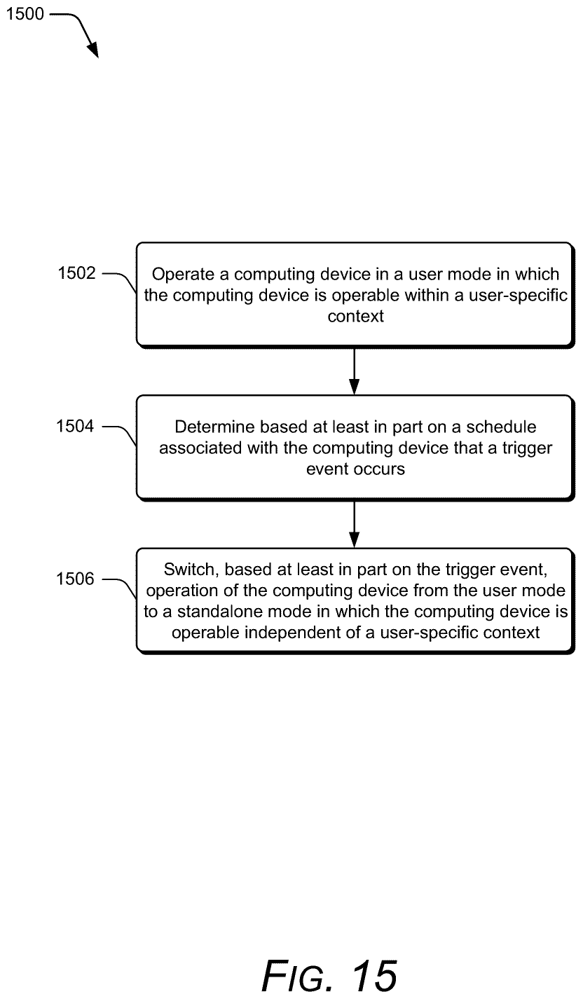

FIG. 15 depicts a method 1500 for operation modes for a computing device in accordance with one or more implementations. At 1502 a computing device is operated in a user mode in which the computing device is operable within a user-specific context. Example attributes of the user mode are discussed above. At 1504 it is determined based at least in part on a schedule associated with the at least one computing device that a trigger event occurs. As described above, for example, the computing device is configured with a schedule that specifies different times at which the computing device is to switch between operation in different operation modes.

At 1506, based at least in part on the trigger event, operation of the computing device is switched from the user mode to a standalone mode in which the computing device is operable independent of a user-specific context.

FIG. 16 depicts an environment 1600 in accordance with one or more implementations. The environment 1600, for instance, is operable independently of and/or in conjunction with the environment 100 described above. The environment 1600 includes switch devices 1602 and a hub device 1604 that can interface via wired and/or wireless connectivity, such as over the network 104. The switch devices 1602 and a hub device 1604, for example, can be communicatively coupled via wireless connectivity, including wireless protocols such as WiFi, wireless cellular, near field wireless communication, etc.

The switch devices 1602 include an actuator 1606 and a switch module 1608. The switch devices 1602, for example, represent devices that are operable to perform various actions such as pertaining to a facility and/or other location in which the switch devices 1602 are installed. In at least one implementation the switch devices 1602 can be implemented as Internet of Things (IoT) devices. The actuator 1606 represents functionality for triggering different actions via the switch devices 1602, examples of which are discussed below. The actuator 1606 can be implemented in various ways, such as a hardware button, an audio sensor, a light sensor, etc. The switch module 1608 represent functionality (e.g., executable logic) for causing execution of various actions associated using the switch devices 1602.

The hub device 1604 includes a hub module 1610 which represents functionality for interfacing with the switch devices 1602 to cause action plans 1612 to be executed. The action plans 1612, for instance, represent executable data that is executable to cause different actions to be performed. In at least one implementation the hub device 1604 can interface with the system server 120 to cause action plans 1612 to be executed. Alternatively or additionally the hub device 1604 can interact with a local facility device such as the computing device 102 to cause the action plans 1612 to be executed. For instance, the hub device 1604 is configurable in a network mode where the hub device 1604 can communicate with the system server 120 to cause various action plans 1612 to be performed, and in a local mode (e.g., a standalone mode) where the hub device 1604 can communicate with the computing device 102 and/or other local device (e.g., a local private branch exchange (PBX) device) to cause action plans 1612 to be performed.

Examples of the action plans 1612 include sending a predefined email, sending a predefined text message, triggering a phone call, controlling a relay, calling a third-party API (e.g., such as implemented via the computing device 102), updating a digital display with a particular message and/or visual object, controlling different sensors located throughout a location, controlling audio output devices, etc. In at least one implementation the switch devices 1602 can invoke different action plans 1612 by invoking an application programming interface (API) that exposes different instances of the action plans 1612. Some examples of specific use case scenarios for implementing actions plans 1612 include:

(1) Operating a light fixture and/or other output device according to a preprogrammed output pattern that may have different prespecified meanings depending on colors and/or patterns. One example light fixture is described below and illustrated in the accompanying drawings.

(2) Operating an audio output device to out different sounds and/or audible output, such as to output different messages.

(3) Outputting an assistance request indication (e.g., audibly, via light output, and combinations thereof), such as to request assistance in a safety emergency such as in work facilities, assisted living facilities, etc.

(4) Presence notification indicating that a particular person is present. For instance, a child can actuate a switch device 1602 at a residence to indicate that the child is present at home.

(5) Operation of machinery connected to a switch device 1602, e.g., a remote gate controller.

(6) Environmental sensing such as detecting the presence of water, differences in air pressure, temperature, motion, etc.

(7) Vehicle presence sensing.

(8) Door opening sensing. For instance, if a door is held open for a specified period of time, a switch device 1602 can send a message to the hub device 1604 and activate an action plan 1612. Consider, for example, that a switch device 1602 is connected to a door and if the door is blocked open for a time period (e.g., 60 seconds) the hub device 1604 can execute an action plan 1612 to send a message to security personnel to let them know the door is blocked open.

(9) Customer Feedback—different switch devices 1602 can be programmed to enable a customer to select a switch to indicate different levels of customer satisfaction/dissatisfaction with a particular good and/or service.

(10) API calls—API call frequency for a switch device 1602 can be configured to conserve system resources. For instance, an admin can specify a periodicity for API calls (e.g., only every x seconds) in response to switch actuation to mitigate system overload with API calls due to repeated switch actuation. Further, in implementations device context can be communicated along with an API call. Examples of device context include internet protocol (IP) address, medium access control (MAC) address, a unique identifier, a current switch status, an intended switch status, a switch location, a switch battery level, etc. Further, device context fields can be configured such as physical address, building, room, contact telephone number, etc.

In implementations device context information from a switch device 1602 can be used for different purposes (e.g., by a hub device 1604), such as for populating into an email message, a text message, an API call, a log message, a notification, etc.

(11) Light Indicator—A light (e.g., light emitting diode (LED)) on a switch device 1602 can be utilized to communicate a status of a message generated and transmitted by the switch device 1602. Further, a light can be utilized to communicate status information regarding a device (e.g., a hub device 1604) to which the switch device 1602 is communicating a message. One example of a light indicator is described below and in the accompanying drawings.

(12) Action Plan Scheduling—action plans that are triggered based on switch device 1602 actuation can be scheduled based on different days, times, calendar dates, etc. For instance, a first action plan can be triggered during work hours (e.g., Monday-Friday 8 am-5 pm) whereas a second action plan can be triggered at other times, e.g., outside of work hours.

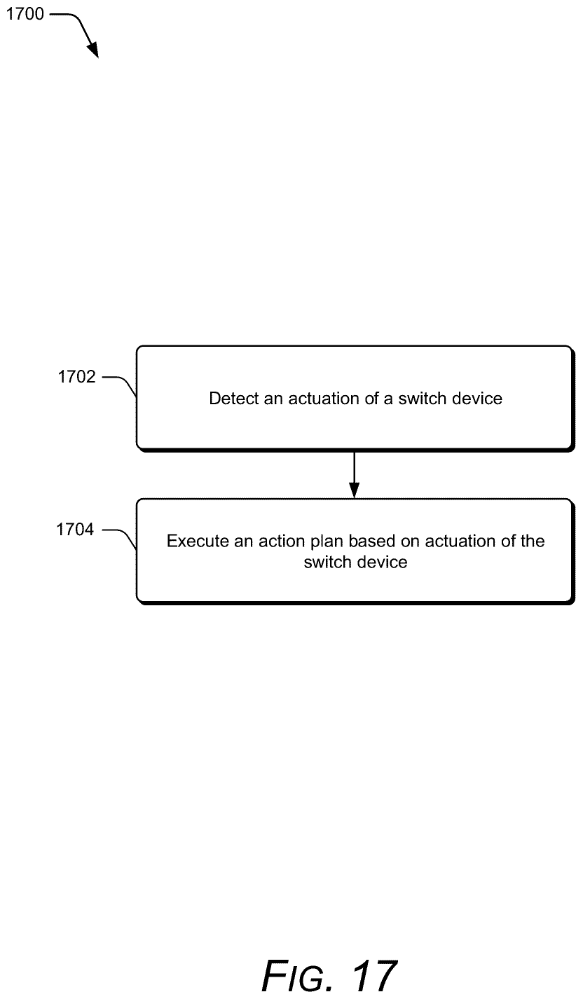

FIG. 17 depicts a method 1700 for utilizing a switch device for implementing an action plan in accordance with one or more implementations. At 1702 an actuation of a switch device is detected. A person, for instance, actuates an actuator 1606 on a switch device 1602. At 1704 an action plan is executed based on actuation of the switch device. For instance, based on actuation of a switch device 1602, the switch device 1602 communicates a signal to the hub device 1604, such as to call an API to execute an action plan 1612. In at least one implementation the hub device 1604 can interact with the computing device 102 and/or the system server 120 to cause an action plan 1612 to be executed. Examples of different action plans 1612 are discussed above.

In implementations as an addition or alternative to dedicated switch devices 1602, a mobile application can be utilized such as on a mobile device, e.g., a wireless cellular phone, a tablet device, a laptop, etc. For instance, the various functionality described herein with reference to a switch device 1602 can be implemented via an application to call an API and trigger various events and action plans, such as via selection of a virtual button. Further, the mobile application can be utilized to check a status of different input and output devices, such as instances of a switch device 1602 and/or a hub device 1604.

In implementations groups of switch devices 1602 can be configured remotely. For instance, when multiple switch devices 1602 are installed at a location, an admin can utilize an application (e.g., the hub module 1610) to locate and configure functionality of the switch devices 1602 as a group. Examples of such configuration include password configuration, network setting configuration, API configuration such as device calls, etc., such as by providing an XLS with the changes and/or via a bulk edit through a configuration program.

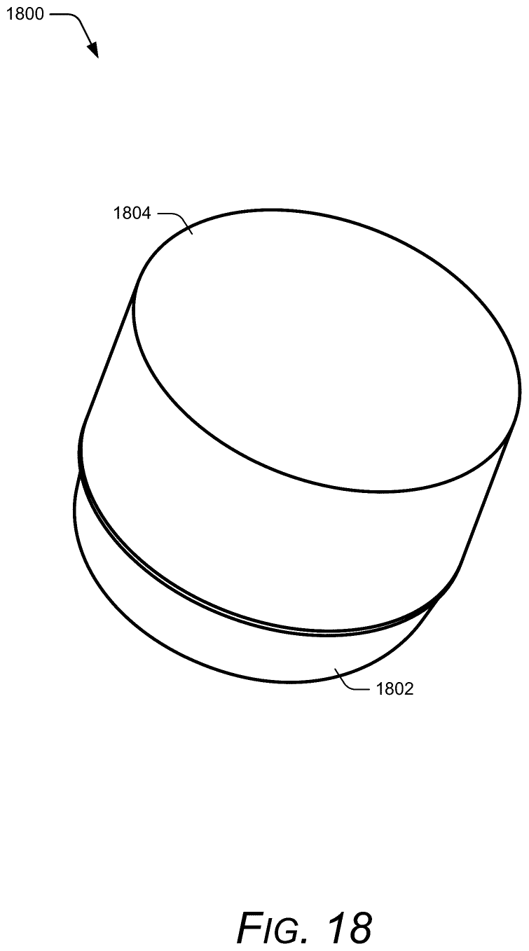

FIG. 18 depicts a light fixture 1800 in accordance with one or more implementations. The light fixture 1800, for example, can be utilized for various purposes, such as for signaling different types of information within a facility. For instance, the light fixture 1800 can be connected (e.g., via wired and/or wireless connectivity) to a switch device 1602 and/or a hub device 1604 to enable different types of information to be conveyed via operation of the light fixture 1800.

The light fixture 1800 includes a base component 1802 and a cap component 1804 attached to the base component 1802. The cap component 1804 can be attached to the base component 1802 using various attachment mechanisms such as via threaded attachment, snap fit joints, clips, screws, adhesive, and/or combinations thereof. According to implementations the base component 1802 is configured to be installed on a surface such as a wall, a ceiling, etc. Further, the cap component 1804 is transparent and/or translucent such that light emitted internally from the light fixture 1800 can be emitted externally from the cap component 1804.

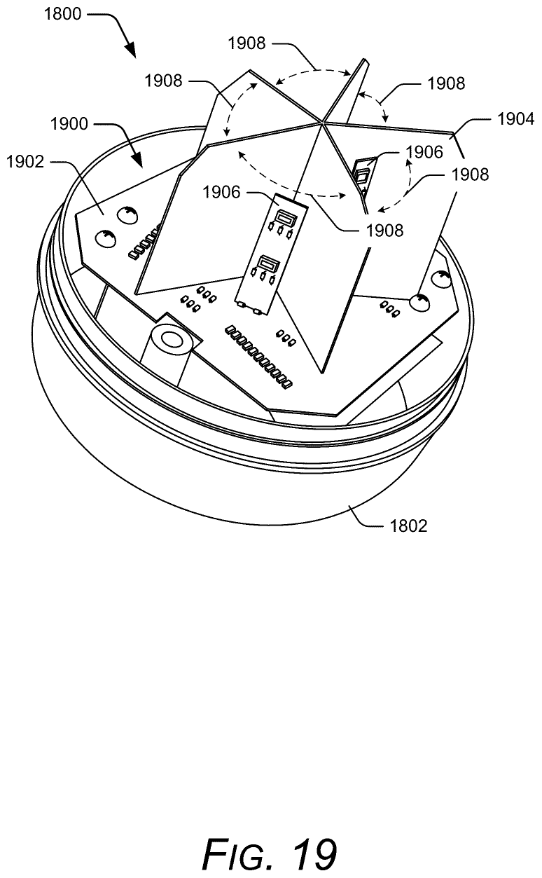

FIG. 19 depicts the light fixture 1800 with the cap component 1804 removed from the base component 1802 in accordance with one or more implementations. The light fixture 1800 includes an internal structure 1900 including a circuit board 1902, a baffle structure 1904 attached to the circuit board 1902, and light components 1906 attached to the circuit board 1902 and arranged within compartments 1908 within the baffle structure 1904. The circuit board 1902 includes various circuitry for operating the light components 1906, such as programmable integrated circuitry. The light components 1906 can be implemented in various ways, such as LED, incandescent lights, and/or other light source. According to implementations each compartment 1908 includes a respective light component 1906 that is separately operable.

According to implementations the circuit board 1902 can be programmed to provide different illumination patterns for the light components 1906, such as different on/off sequences for each light component 1906. Further, the baffle structure 1904 enables light emission control from the light fixture 1800, particularly with the cap component 1804 installed on the base component 1802. For instance, with the cap component 1804 installed on the base component 1802, the baffle structure 1904 mitigates light leakage between different compartments 1908 when individual light components 1906 are illuminated.

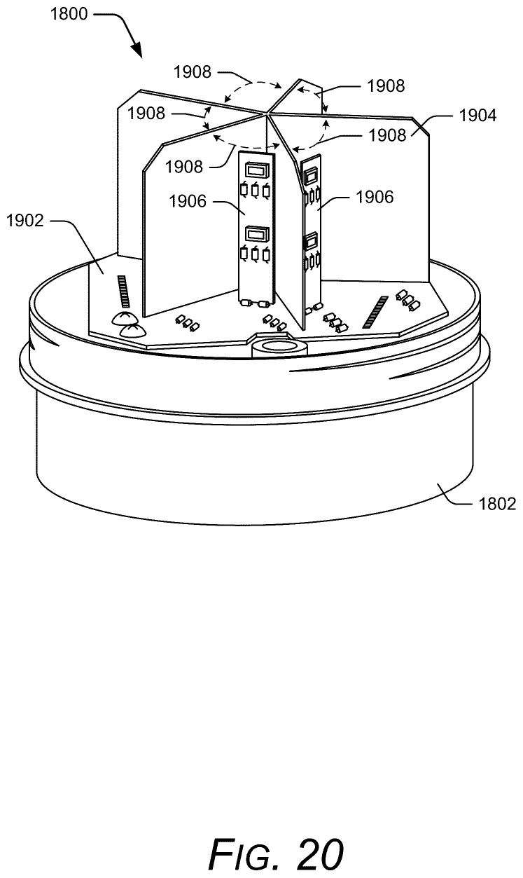

FIG. 20 depicts the light fixture 1800 with the cap component 1804 removed from the base component 1802 in accordance with one or more implementations. This view of the light fixture 1800 includes the base component 1802, the circuit board 1902, the baffle structure 1904, light components 1906, and compartments 1908.

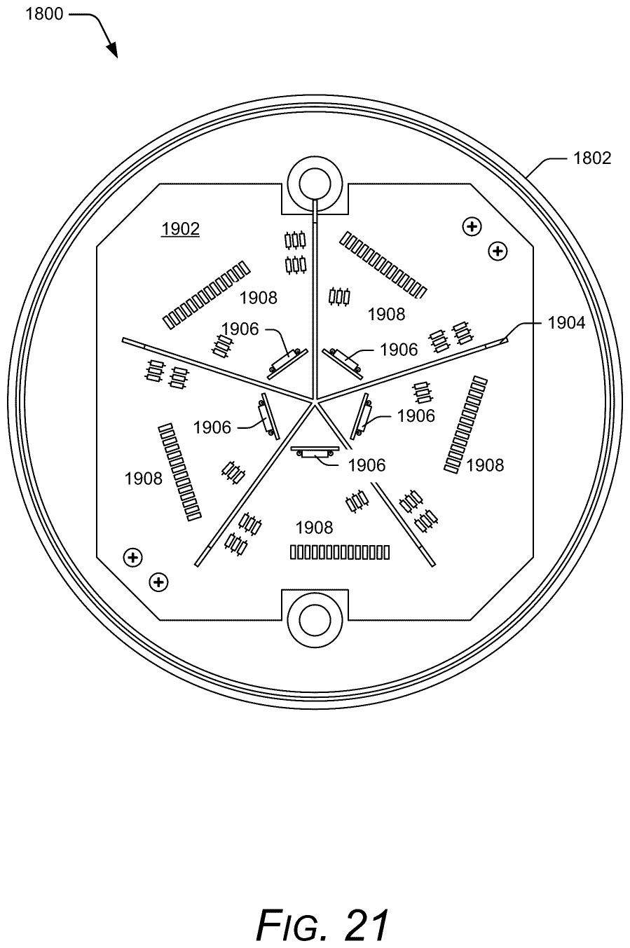

FIG. 21 depicts an overhead view of the light fixture 1800 with the cap component 1804 removed from the base component 1802 in accordance with one or more implementations. This view of the light fixture 1800 includes the base component 1802, the circuit board 1902, the baffle structure 1904, light components 1906, and compartments 1908.

While the light fixture 1800 is illustrated herein as including five baffles as part of the baffle structure 1904 and five light components 1906, it is to be appreciated that any number of baffles and/or light components 1906 can be implemented in accordance with the disclosed and claimed implementations. Further, each of the light components 1906 is configurable to emit any particular light color and/or light pattern, such as via programming of the switch devices 1602 and/or the hub device 1604 to configure operation of the light fixture 1800 and/or group of light fixtures 1800.

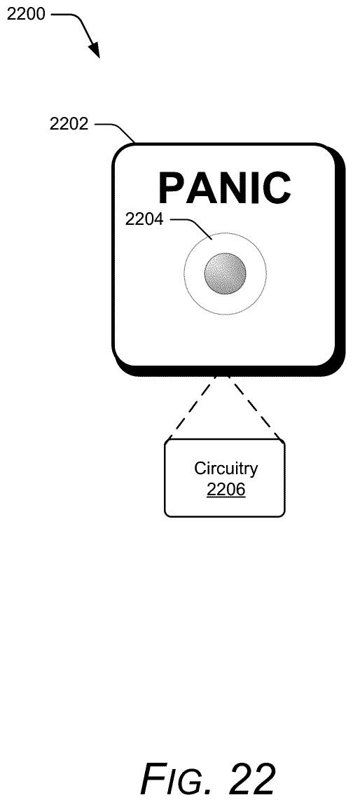

FIG. 22 depicts an example alert device 2200 in accordance with one or more implementations. The alert device 2200 can include various functionality and/or circuitry, such as described with reference to the computing devices 102, 2302. The alert device 2200 includes a housing 2202, a button 2204, and circuitry 2206. According to implementations the housing 2202 can be installed on any surface, such as a wall, furniture, a door etc. The button 2204 is selectable to actuate various functionality of the alert device 2200, such as to trigger various events configured via the circuitry 2206.

In implementations the circuitry 2206 includes functionality for wired and/or wireless connectivity such as to a network service such as the system server 120. For instance, to install the alert device 2200, a user may install the alert device 2200 and then activate the alert device 2200 such as by visiting an activation website and entering a device ID for the alert device 2200, entering the user's billing information, and the user's contact information for generating events (e.g., an emergency assistance request) when the button 2204 is pressed. For example, when the button 2204 is actuated, a monitoring can receive an alert and attempt to contact the user. If the user does not respond, an emergency protocol can be initiated, such as via sending security personnel (e.g., law enforcement) to a location identified as part of registration of the alert device 2200. Various events (e.g., action plans) can be programmed to be triggered in response to selection of the button 2204, examples of which are described above.

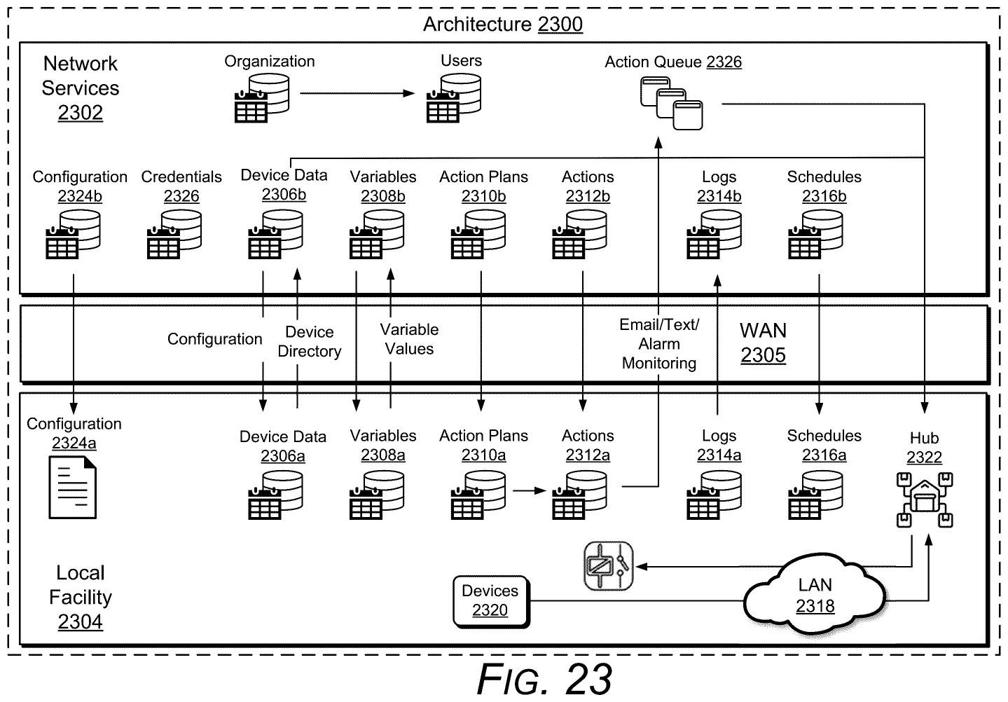

FIG. 23 depicts an example architecture 2300 in accordance with one or more implementations. The architecture 2300, for instance, can employed as part of the various implementations described herein. The architecture 2300 includes various hardware and logic including network services 2302 and a local facility 2304. Further, the network services 2302 and the local facility 2304 can communicate via a wide area network (WAN) 2305.

The local facility 2304 represents a location and/or set of locations (e.g., physical facilities) in which the various implementations are operable, examples of which are described throughout this disclosure. The local facility 2304 includes various devices and functionality for performing the described implementations including device data 2306a which represents data that can be used in configuration and operation of various devices at the local facility 2304, examples of the devices are discussed above; variables 2308a which represents data that can be used to specify and customize various system behaviors: action plans 2310a which represents data for different action plans, examples of which are described above; actions 2312a which represent data for performing various actions such as actions specified by the action plans 2310a; logs 2314a which represent data for tracking different user and system behaviors, such as based on user interactions with devices at the local facility 2304; and schedules 2316a which represent data that specifies different user and system schedules, examples of which are detailed above. In at least one implementation the device data 2306a includes mode data for different operating modes, such as described with reference to the operation modes 122.

According to implementations the network services 2302 maintain a data state of the various logic and functionality described above with reference to the local facility 2304 including device data 2306b, variables 2308b, action plans 2310b, actions 2312b, logs 2314b, and schedules 2316b. This different data is stored at the network services 2302 and can be used to configure the corresponding data at the local facility 2304, such as via data communication across the WAN 2305. The local facility 2304, however, is operable independent of the network services 2302. For instance, if connectivity to the WAN 2305 is lost at the local facility 2304, a current state of the various data is maintained such that the various hardware and functionality of the local facility 2304 can continue to operate independent of the network services 2302. When connectivity to the WAN 2305 is restored at the local facility 2304 changes to the various data at the local facility 2304 can be communicated to the network services 2302 to update a data state of the local facility 2304 at the network services 2302.

The local facility 2304 also includes a local area network (LAN) 2318 via which various devices at the local facility 2304 can communicate. For instance, devices 2320 are connected to a hub 2322 via the LAN 2318. The devices 2320 represent various instances of devices that can be implemented at the local facility 2304 such as a computing device 102, a switch device 1602, a light fixture 1800, an alert device 2200, a kiosk device, and/or any other suitable device. Further, the hub 2322 represents hardware and logic for interconnecting various devices at the local facility 2304 (e.g., different instances of the devices 2320) and for performing data routing, such as data event routing across the local facility 2304. The hub 2322, for instance, represents an instance of the hub device 1604 described above.

The local facility 2304 also maintains configuration 2324a which represents data that can be used for configuring various devices and functionality of the local facility 2324a, and the network services 2302 maintain configuration 2314b which represents a version of the 2324a. To enable various actions to be performed at the local facility 2304 the action plans 2310a can cause actions 2312a to be triggered, such as described above. Further, actions 2312a can be communicated to the network services 2302 and populated to an action queue 2326, and the actions 2312a can be communicated from the action queue 2326 to the hub 2322 to cause the actions 2312a to be performed such as via the devices 2320. Examples of the actions 2312a include email generation, email delivery, text generation, text delivery, alarm monitoring, alarm output, etc. Other examples of the actions 2312a are described above. The network services 2302 also maintain credentials 2326 which represent authentication credentials for enabling devices as the local facility 2304 to access the network services 2302 and for enabling the network services 2302 to access devices at the local facility 2304.

Accordingly, the architecture 2300 provides a distributed environment in which functionality at the local facility 2304 can be remotely configured and maintained via the network services 2302 while ensuring that the functionality of the local facility 2304 remains fully functional should access to the network services 2302 be interrupted.

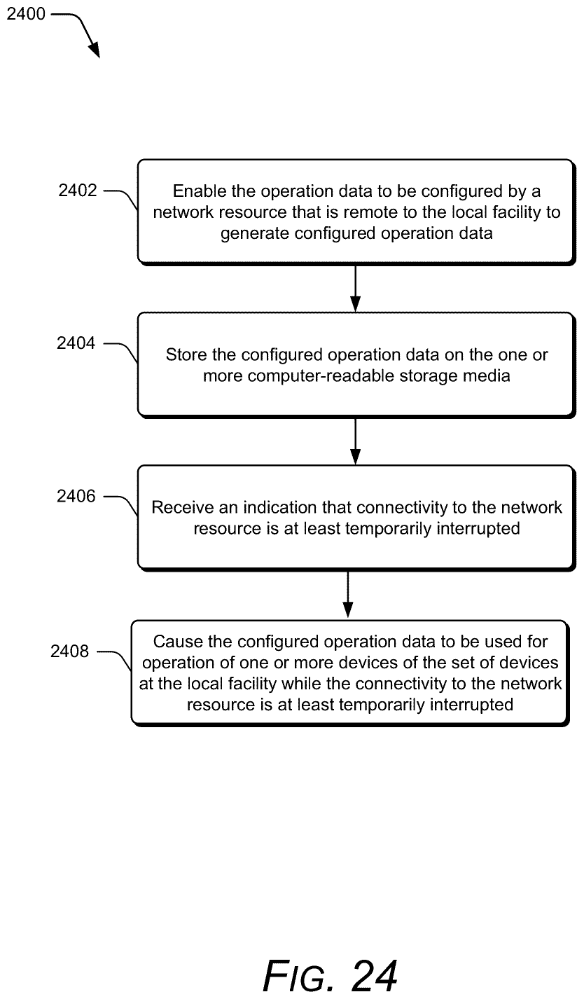

FIG. 24 depicts a method 2400 for facility operation in the context of a distribute architecture in accordance with one or more implementations. The method 2400, for example, provides example ways for configuration and operation of the architecture 2300. At 2402 the operation data is enabled to be configured by a network resource that is remote to the local facility to generate configured operation data. The local facility 2304, for instance, is connected to the network services 2302 such that the network services 2302 can configure the operation data, such as operational data for operation of the devices 2320 located at the local facility 2304.

At 2404 the configured operation data is stored on the one or more computer-readable storage media. The one or more computer-readable storage media, for instance, represent data storage hardware that is located at the local facility and that stores various data usable at the local facility, including the configured operational data generated at least in part by the network resource 2302.

At 2406 an indication is received at the local facility that connectivity to the network resource is at least temporarily interrupted. One or more devices at the local facility 2304, for instance, detect that connectivity to the network services 2302 is interrupted, e.g., at least temporarily not available. In at least one implementation the hub 2322 manages and/or monitors network connectivity for the local facility 2304 and thus can detect that the network connectivity is not available.

At 2408 the configured operation data is caused to be used for operation of one or more devices of the set of devices at the local facility while the connectivity to the network resource is at least temporarily interrupted. One or more of the devices 2320, for instance, utilize locally stored data at the local facility 2304 for operation and do not attempt to utilize remotely stored data such as from the network services 2302. In at least one implementation the hub 2322 notifies one or more of the devices 2320 that network connectivity is interrupted and that the one or more devices 2320 are to utilize locally stored data for operation.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

### Example System and Device

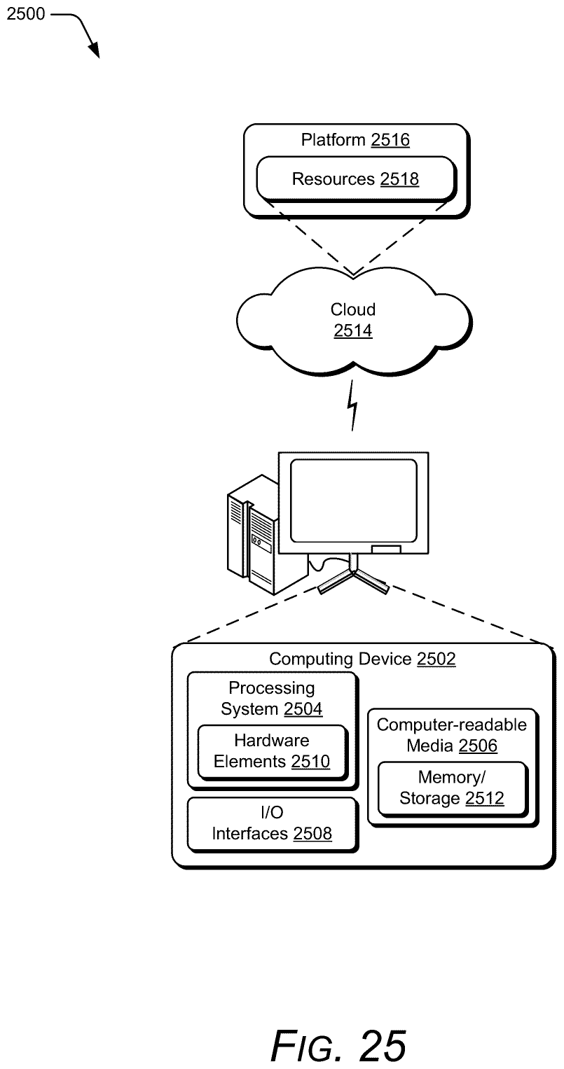

FIG. 25 illustrates an example system 2500 that includes an example computing device 2502 that is representative of ones or more computing systems and/or devices that are usable to implement the various techniques described herein. For instance, any one or more of the devices and/or apparatus described above can be implemented at least in part via the computing device 2502. The computing device 2502 includes, for example, a server of a service provider, a device associated with a client (e.g., a client device), an on-chip system, and/or any other suitable computing device or computing system.

The example computing device 2502 as illustrated includes a processing system 2504, one or more computer-readable media 2506, and one or more I/O interfaces 2508 that are communicatively coupled, one to another. Although not shown, the computing device 2502 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 2504 is representative of functionality to perform one or more operations using hardware. Accordingly, the processing system 2504 is illustrated as including hardware elements 2510 that are be configured as processors, functional blocks, and so forth. This includes example implementations in hardware as an application specific integrated circuit or other logic device formed using one or more semiconductors. The hardware elements 2510 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 2506 is illustrated as including memory/storage 2512. The memory/storage 2512 represents memory/storage capacity associated with one or more computer-readable media. In one example, the memory/storage component 2512 includes volatile media (such as random access memory (RAM)) and/or nonvolatile media (such as read only memory (ROM), Flash memory, optical disks, magnetic disks, and so forth). In another example, the memory/storage component 2512 includes fixed media (e.g., RAM, ROM, a fixed hard drive, and so on) as well as removable media (e.g., Flash memory, a removable hard drive, an optical disc, and so forth). The computer-readable media 2506 is configurable in a variety of other ways as further described below.

Input/output interface(s) 2508 are representative of functionality to allow a user to enter commands and information to computing device 2502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 2502 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that that is accessible to the computing device 2502. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 2502, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 2510 and computer-readable media 2506 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 2510. For example, the computing device 2502 is configured to implement particular instructions and/or functions corresponding to the software and/or hardware modules. Accordingly, implementation of a module that is executable by the computing device 2502 as software is achieved at least partially in hardware, e.g., through use of computer-readable storage media and/or hardware elements 2510 of the processing system 2504. The instructions and/or functions are executable/operable by one or more articles of manufacture (for example, one or more computing devices 2502 and/or processing systems 2504) to implement techniques, modules, and examples described herein.

The techniques described herein are supportable by various configurations of the computing device 2502 and are not limited to the specific examples of the techniques described herein. This functionality is also implementable entirely or partially through use of a distributed system, such as over a “cloud” 2514 as described below.

The cloud 2514 includes and/or is representative of a platform 2516 for resources 2518. The platform 2516 abstracts underlying functionality of hardware (e.g., servers) and software resources of the cloud 2514. For example, the resources 2518 include applications and/or data that are utilized while computer processing is executed on servers that are remote from the computing device 2502. In some examples, the resources 2518 also include services provided over the Internet and/or through a subscriber network, such as a cellular or Wi-Fi network.

The platform 2516 abstracts the resources 2518 and functions to connect the computing device 2502 with other computing devices. In some examples, the platform 2516 also serves to abstract scaling of resources to provide a corresponding level of scale to encountered demand for the resources that are implemented via the platform. Accordingly, in an interconnected device embodiment, implementation of functionality described herein is distributable throughout the system 2500. For example, the functionality is implementable in part on the computing device 2502 as well as via the platform 2516 that abstracts the functionality of the cloud 2514.

Although implementations of operation modes for a computing device have been described in language specific to features and/or methods, the subject of the appended claims is not necessarily limited to the specific features or methods described. Rather, the features and methods are disclosed as example implementations of operation modes for a computing device, and other equivalent features and methods are intended to be within the scope of the appended claims. Further, various different examples are described, and it is to be appreciated that each described example can be implemented independently or in connection with one or more other described examples.

1. An apparatus, comprising:
at least one memory; and
at least one processor coupled to the at least one memory and configured to cause the apparatus to:
configure at least one computing device to operate in an operation mode, the operation mode selected from:
a standalone mode in which the computing device is operable independent of a user-specific context;
a user mode in which the computing device is operable within a user-specific context; and
a schedule mode in which the computing device is operable to switch between different operation modes according to a specified schedule;
configure permissions of the computing device based at least in part on the configured operation mode; and
cause operation of the computing device according to the configured operation mode and the configured permissions.

2. The apparatus of claim 1, wherein the at least one processor is configured to cause the apparatus to:
communicate a profile request requesting a device profile for the at least one computing device; and
receive the device profile, wherein the device profile identifies the operation mode for configuring the at least one computing device.

3. The apparatus of claim 2, wherein the device profile comprises an operation schedule that specifies that the at least one computing device is to switch from the operation mode to a different operation mode at a scheduled time.

4. The apparatus of claim 2, wherein the device profile comprises device permissions that specify allowed device access based on the operation mode.

5. The apparatus of claim 1, wherein the operation mode comprises the standalone mode, and wherein the at least one processor is configured to cause the apparatus to select a system profile for operation of the at least one computing device within the standalone mode.

6. The apparatus of claim 1, wherein the operation mode comprises the user mode, and wherein the at least one processor is configured to cause the apparatus to configure a set of user profiles that are permitted to access functionality of the at least one computing device within the user mode.

7. The apparatus of claim 1, wherein the operation mode comprises the schedule mode, and wherein the at least one processor is configured to cause the apparatus to configure a schedule of the at least one computing device to specify a schedule for automatically switching between operation in the standalone mode and operation in the user mode.

8. The apparatus of claim 7, wherein the at least one processor is configured to cause the apparatus to:
configure the schedule of the at least one computing device to specify a schedule for automatically switching between operation in the user mode and operation in the standalone mode; and
configure a switching behavior that specifies a type of notification to be output when switching between operation in the user mode and operation in the standalone mode, and an action to be performed when a user profile is authenticated with the at least one computing device when a scheduled switch between the user mode and the standalone mode occurs.

9. The apparatus of claim 1, wherein the at least one processor is configured to cause the apparatus to configure the at least one computing device to specify whether user switching between the standalone mode and the user mode is permitted.

10. An apparatus comprising:
at least one memory; and
at least one processor coupled to the at least one memory and configured to cause the apparatus to:
receive user interaction to invoke at least one computing device;
present, in response to the user interaction, a user experience on the at least one computing device according to an active operation mode, the active operation mode selected from:
a standalone mode in which the computing device is operable independent of a user-specific context; and
a user mode in which the computing device is operable within a user-specific context; and
operate the computing device according to the user experience and based at least in part on a profile associated with the active operation mode.

11. The apparatus of claim 10, wherein the active operation mode comprises the standalone mode, the standalone mode is associated with multiple system profiles, and a system profile for operation in the standalone mode is selected from the multiple system profiles based on one or more of a time parameter or an identity of a user that is interacting with the at least one computing device.

12. The apparatus of claim 10, wherein the standalone mode is associated with a first set of permissions, the user mode is associated with a second set of permissions, and the at least one processor is configured to cause the apparatus to apply one of the first set of permissions or the second set of permissions to operation of the at least one computing device based on which of the standalone mode or the user mode is the active operation mode.

13. The apparatus of claim 10, wherein the standalone mode is associated with a first set of web browser behaviors, the user mode is associated with a second set of web browser behaviors, and the at least one processor is configured to cause the apparatus to apply one of the first set of web browser behaviors or the second set of web browser behaviors to operation of the at least one computing device based on which of the standalone mode or the user mode is the active operation mode.

14. The apparatus of claim 10, wherein the at least one processor is configured to cause the apparatus to operate the at least one computing device in a schedule mode that comprises a schedule for switching the active operation mode between the standalone mode and the user mode.

15. The apparatus of claim 14, wherein the active operation mode comprises the user mode, and the at least one processor is configured to cause the apparatus to:
determine that the schedule specifies that the active operation mode is to be switched from the user mode to the standalone mode;
determine that a user profile is currently authenticated on the at least one computing device in the user mode; and
output a notification that indicates that a switch from the user mode to the standalone mode is scheduled, and that provides for one or more available user-selected actions to be performed before switching to the standalone mode.

16. A system comprising:
one or more switch devices each comprising an actuator and a switch module; and
a hub device operably connected to the one or more switch devices and configured to:
receive, from the one or more switch devices, an indication of an actuation of an actuator;
invoke an application programming interface (API) based at least in part on the indication of the actuation of the actuator; and
cause one or more action plans to be executed based at least in part on invocation of the API.

17. The system of claim 16, wherein the hub device is configured to apply a time threshold to invocation of the API in response to actuation of the actuator.

18. The system of claim 16, wherein the hub device is configured to generate a context message that includes context information pertaining to the one or more switch devices, and transmit the context message.

19. The system of claim 16, wherein the one or more action plans comprise a first action plan configured for a first time slot and a second action plan configured to a second time slot.

20. The system of claim 16, further comprising a light fixture operably coupled to at least one of the one or more switch devices or the hub device and being operable to be invoked based at least in part on the one or more action plans, the light fixture comprising:
a base component;
a cap component attached to the base component;
an internal structure attached to the base component and including a baffle structure with multiple baffles forming multiple compartments; and
one or more light components positioned within each compartment and being separately operable to enable different light sequences of the one or more light components.

21. A system comprising:
a set of devices at a local facility;
one or more computer-readable storage media at the local facility, the one or more computer-readable storage media storing operation data that includes computer-executable instructions for operation of the set of devices; and
one or more processors coupled with the one or more computer-readable storage media and configured to cause the system to:
enable the operation data to be configured by a network resource that is remote to the local facility to generate configured operation data;
store the configured operation data on the one or more computer-readable storage media;
receive an indication at the local facility that connectivity to the network resource is at least temporarily interrupted; and
cause the configured operation data to be used for operation of one or more devices of the set of devices at the local facility while the connectivity to the network resource is at least temporarily interrupted.
